(19) United States
(12) Patent Application Publication
(10) Pub. No.: US 2002/0005393 A1
(43) Pub. Date: Jan. 17, 2002

(54) MULTI-ELECTRODE WELDING SYSTEM

(76) Inventor: RODERICK G. ROHRBERG, TORRANCE, CA (US)

Correspondence Address: ANGLIN & GIACCHERINI, POST OFC BOX 1146, CARMEL VALLEY, CA, 93924

(21) Appl. No.: 09/368,462

(22) Filed: Aug. 4, 1999

(51) Int. Cl. B23K 9/02; B23K 9/16; B23K 35/38

(52) U.S. Cl. 219/60 A; 219/60 R; 219/61; 219/72; 219/74; 219/75; 219/125.1; 219/125.11; 219/136

(57) ABSTRACT

A Multi-Electrode Welding System for performing high-precision welding and joining is disclosed. One embodiment of the invention comprises a sealed chamber (13) which is enclosed by a weld head frame (11), a removable lid (12) and a chamber base (14). A generally tubular workpiece (not shown) is placed in a pair of semi-annular inserts (16) and extends into the sealed chamber (13), which is filled with an inert gas. In one embodiment, a weld head rotor (18) revolves around the longitudinal axis defined by the workpiece, and controls the motion of an inside electrode (24A) and an outside electrode (24B), which are held by inside and outside electrode holders (20 & 22). Arc welding is performed by the electrodes (24A & 24B) as they revolve around the workpiece. Inside and outside welding may be performed simultaneously. The invention provides for precise control of the relative position of the electrodes, allowing one electrode to trail the other. The invention may incorporate more than one weld head, and may utilize more than one drive motor.

### CROSS-REFERENCES TO A RELATED PATENT & A RELATED PATENT APPLICATION

The present Patent Application is related to an issued U.S. Pat. No. 5,837,968 and a pending U.S. patent application Ser. No. 08/852,324. The Applicant hereby claims the benefit of priority for any and all subject matter disclosed in a related U.S. Pat. No. 5,837,968 entitled Computer-Controlled Modular Power Supply for Precision Welding issued on Nov. 17, 1998; a related, pending U.S. patent application Ser. No.08/852,324, filed on May 7, 1997.

### FEDERALLY SPONSORED RESEARCH OR DEVELOPMENT

None.

### FIELD OF THE INVENTION

The present invention includes methods and apparatus for welding andj oining a wide variety of metal, plastic, composite or other types of workpieces. More particularly, the Multi-Electrode Welding System is a compact, versatile and highly effective machine tool that is capable of forming inside or outside welds on tubular stock.

### BACKGROUND OF THE INVENTION

The worldwide aerospace industry is constantly confronted with obsolete fabrication technology and equipment that cannot keep pace with the technological requirements of today's and tomorrow's aircraft requirements. Each year the aerospace machine tool industry encounters new demands of engineers who specify increasingly complex machining processes for the manufacture of metal parts. One of greatest challenges confronting designers in the precision metal working industry is finding more precise and dependable techniques to join or to weld metal or plastic parts that may have exceedingly small dimensional tolerances or that may be fabricated from exotic metals and alloys, such as titanium, Inconel™ or hybrid stainless steels. The aircraft and aerospace industries are constantly confronted by difficulties that arise when hollow cylindrical metal, plastic or composite conduits need to be joined or welded.

The problem of providing a high-precision tool that can be used to weld or otherwise join metals, plastics, composites and other materials has presented a major challenge to engineers and technicians in the materials industry. The development of an accurate and versatile system that overcomes the difficulties encountered when conventional welders are utilized would constitute a major technological advance in the metal fabrication business. The enhanced performance that could be achieved using such an innovative device would satisfy a long felt need within the industry and would enable machine tool equipment manufacturers and users to save substantial expenditures of time and money.

### SUMMARY OF THE INVENTION

The Multi-Electrode Welding System disclosed and claimed below solves many problems encountered by conventional welders. The Multi-Electrode Welding System is capable of precisely joining metal, plastics, composites and other materials. The present invention offers a compact, portable and easy-to-use tool for the welding industry. One of the preferred embodiments of the invention comprises a generally cubical tool that includes a weld head frame, a lid and a chamber base. The chamber formed within the frame, lid and base is designed to contain a volume of a generally inert gas that may be used for arc welding and for other joining operations. The chamber may be evacuated and back filled with a generally inert gas that is suitable for arc welding. The chamber may also be purged with an inert gas without evacuating.

In one embodiment of the invention, two electrodes situated within the chamber are utilized to perform inside and outside welds on a metal tube. Although one preferred embodiment of the invention uses one inside and one outside electrode, alternative embodiments of the invention may include any number and any combination of inside and/or outside electrodes. The invention includes a gear and power train which provides precise control of the orbital motion of the electrodes. The motion of each electrode is independently controllable, and one electrode may trail another as they move relative to the workpiece.

An appreciation of other aims and objectives of the present invention and a more complete and comprehensive understanding of this invention maybe achieved by studying the following description of preferred and alternative embodiments and by referring to the accompanying Drawings.

### A BRIEF DESCRIPTION OF THE DRAWINGS

I. FIGS. 1 through 11A-Multi-Chamber Welder

FIG. 1 is a perspective front view of the outside of the Multi-Electrode Welding System, revealing a weld head frame, a chamber base and a lid. FIGS. 1A, 1B, 1C and 1D supply photographs of the invention.

FIGS. 2 and 2A offer perspective front views of the invention that reveals the weld head rotor and electrodes that occupy the chamber enclosed by the weld head frame, the chamber base and the lid.

FIGS. 3 and 3A present additional perspective front views like FIG. 2, but with the chamber base and workpiece inserts removed.

FIG. 4 supplies a cross-sectional view of one embodiment of the invention, revealing the electrode holders and associated elements. FIGS. 4A, 4B, 4C, 4D and 4E furnish additional views of the invention.

FIG. 5 is a rear view of one embodiment of the invention that includes a dielectric housing, an I.D. spindle and I.D. and O.D. brush assemblies. FIGS. 5A and 5B provide cross-sectional views.

FIG. 6 provides a partially exploded rear view of the interior elements of one embodiment of the invention.

FIGS. 7 and 7A offer rear views of the internal workings of one embodiment of the present invention.

FIGS. 8, 8A, 8B, 8C and 8D depict elements of various embodiments of a drive train.

FIG. 9 is a perspective front view of the invention that reveals the weld head rotor and electrodes that occupy the chamber enclosed by the weld head frame, the chamber base and the lid.

FIG. 10 is a perspective view of one embodiment of the drive train.

FIG. 11 reveals another view of a drive train. FIG. 11A supplies a cut-away cross-sectional view of one embodiment of the invention.

II. FIGS. 101A through 112-A Power Supply

FIGS. 101A, 101B, 101C, 101D, 101E, 101F, 101G, 101H and 101I are isometric views of a preferred embodiment of the present invention.

FIGS. 102 and 103 are block diagrams which portray the functional capabilities of the present invention and the many possible connections to input, storage and peripheral devices.

FIGS. 104 through 109 are reproductions of photographs of the output of the display. This sequence of drawings illustrates the easy-to-use computer program which provides precise and automatic control of the present invention.

FIGS. 110, 111 and 112 furnish schematic diagrams of the electronic components of a preferred embodiment of the present invention.

III. FIGS. 201 through 212-Electronic Control Schematics

FIG. 201 is a schematic diagram of a welder micro-controller.

FIG. 202 is a schematic diagram which shows a current loop.

FIG. 203 is a schematic diagram which explains data conversion.

FIG. 204 is a schematic diagram that depicts motor control circuitry.

FIG. 205 is a schematic diagram that depicts motor power and control circuitry.

FIG. 206 is a schematic diagram of a processor.

FIG. 207 is a schematic diagram which shows circuitry related to memory and input/output decoding.

FIG. 208 is a schematic diagram of an input/output interface.

FIG. 209 is a schematic diagram of a motor control circuit.

FIG. 210 is a another schematic diagram which shows motor control circuitry. FIG. 211 is a schematic diagram of a power module current control circuit. FIG. 212 is a schematic diagram of a current source select circuit.

### DETAILED DESCRIPTION OF PREFERRED & ALTERNATIVE EMBODIMENTS

I. Multi-Electrode Welder

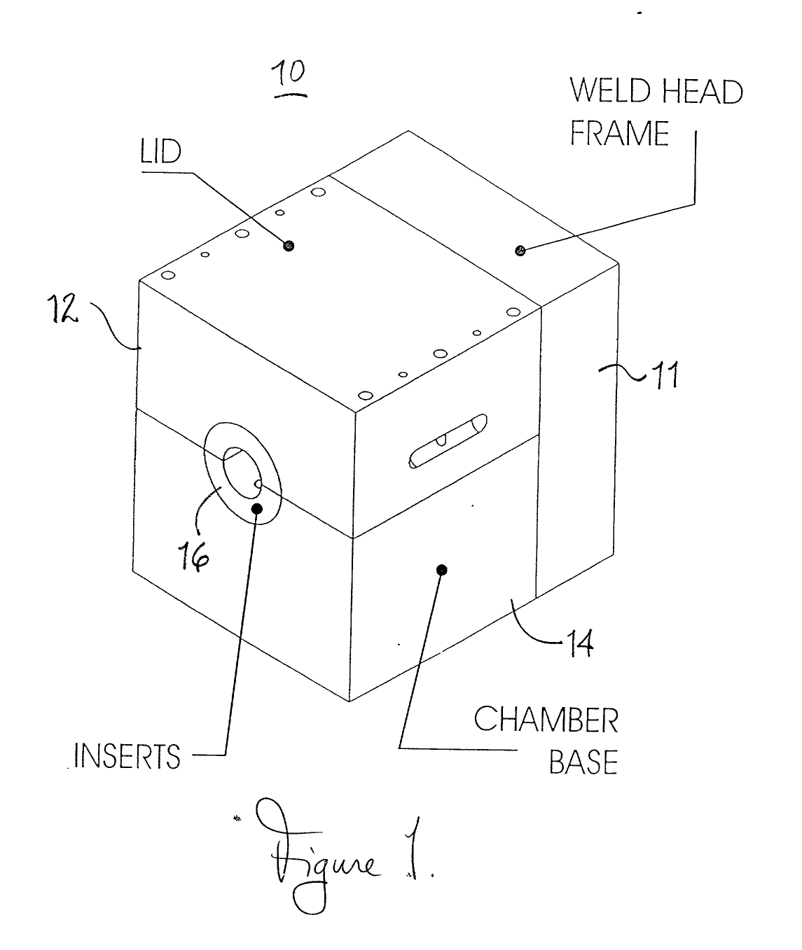

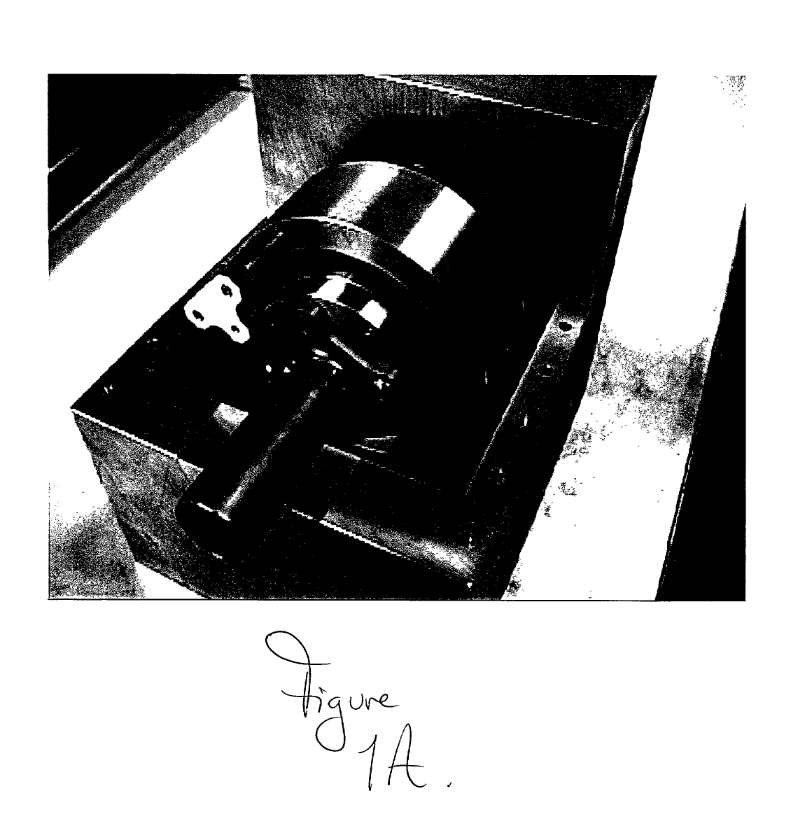

FIG. 1 presents an illustration of one of the preferred embodiments of the Multi-Electrode Welding System 10, revealing a weld head frame 11, a chamber base 14 and a lid 12 which closes down on the base 14 to form a tight seal. The frame 11, lid 12 and base 14 form an enclosure or chamber 13, which is designed to contain a volume of a generally inert gas that may be used for arc welding operations. Although FIGS. 1, 1A, 1, 1B, 1C and 1D exhibit a generally cubical metal embodiment of the invention, any configuration or means which affords a readily accessible sealed chamber for gas welding will serve to implement the invention.

A workpiece is introduced into the chamber 13 through a pair of semi-annular inserts 16 that hold the workpiece (not shown), and maintain the chamber gas seal. In one embodiment of the invention, the workpiece is a generally cylindrical, tubular length of specialized aerospace metal such as titanium. Once the workpiece is securely in place, the chamber 13 may be evacuated and back filled with a generally inert gas that is suitable for arc welding. The chamber 13 may also be purged with an inert gas without evacuating. In one embodiment of the invention, argon is used as the inert gas.

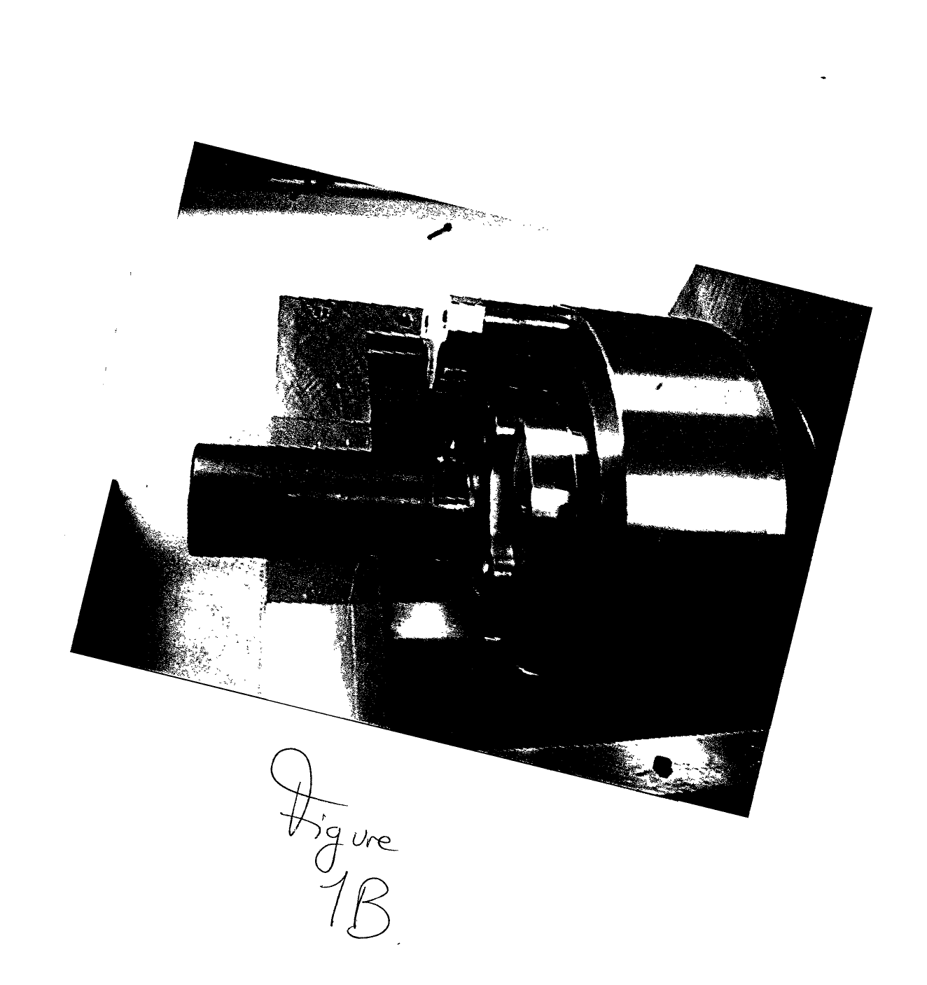

FIGS. 2 and 2A reveal some of the working components of the present invention. A weld head rotor 18, which is driven by a series of gears and motors depicted in other drawings, resides within the chamber 13 and controls the motion of inside and outside electrode holders 20 & 22.

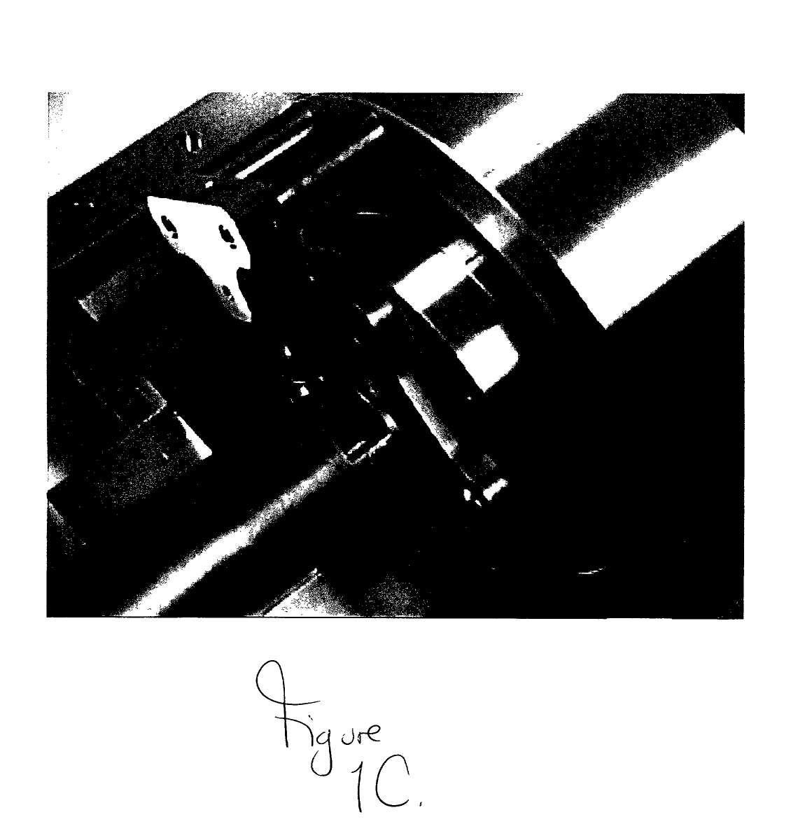

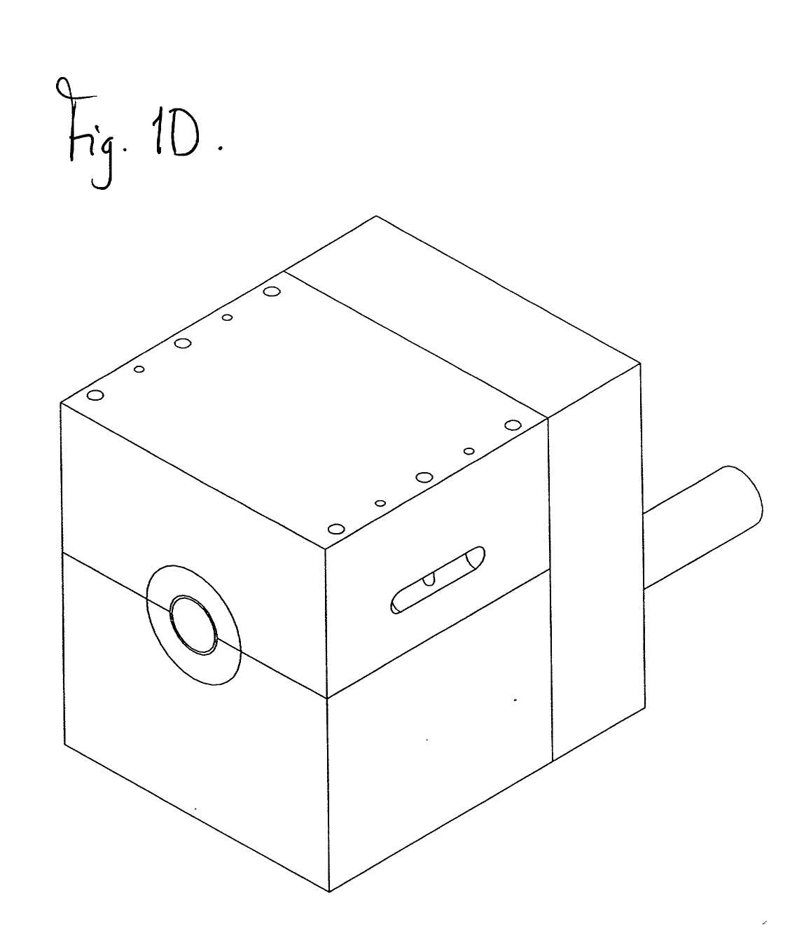

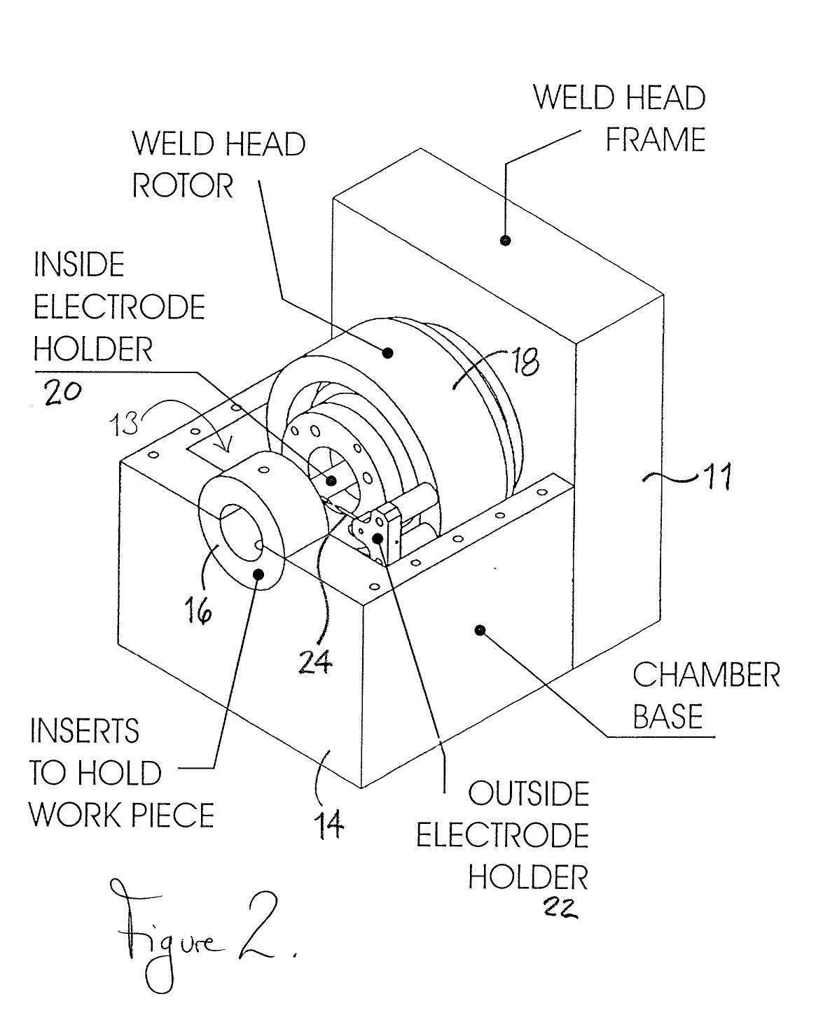

FIGS. 3, 3A, 4, 4A, 4B, 4C, 4D and 4E reveal additional details of the interior of the present invention. In FIG. 3, the lid 12 and base 14 have been removed to show the rotor 18, the inside electrode holder 20, the inside and outside diameter electrodes (24A & 24B) and the rotor and central drive shaft motor 26 which powers the rotor 18. FIG. 4 supplies a cross-sectional view through the weld head frame 11 and base 14, offering a detailed portrayal of a rotor outside diameter electrode holder 28, an inside diameter spindle electrode holder 30, flexing taper fingers 32 and a taper lock nut 34.

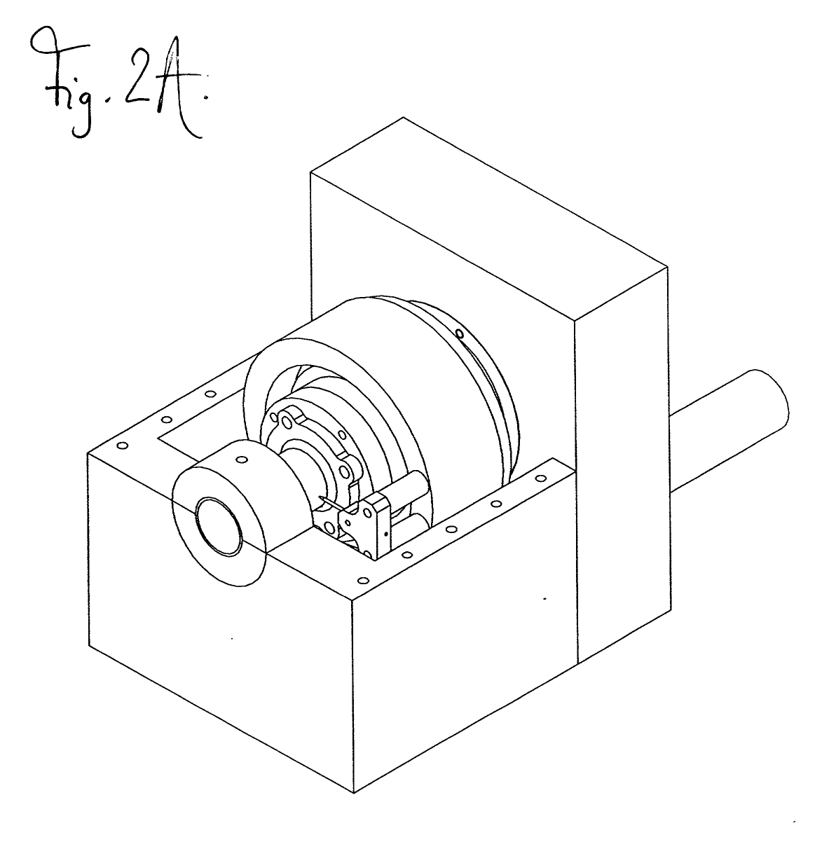

FIGS. 5A and 5B are cross-sectional views of various embodiments of the invention. These views show a dielectric housing 40, an inside diameter spindle 42 and outside diameter and inside diameter brush assemblies 36 & 38. The dielectric housing 40 serves as a insulator which electrically isolates the exterior of the invention form the active components within the chamber 13.

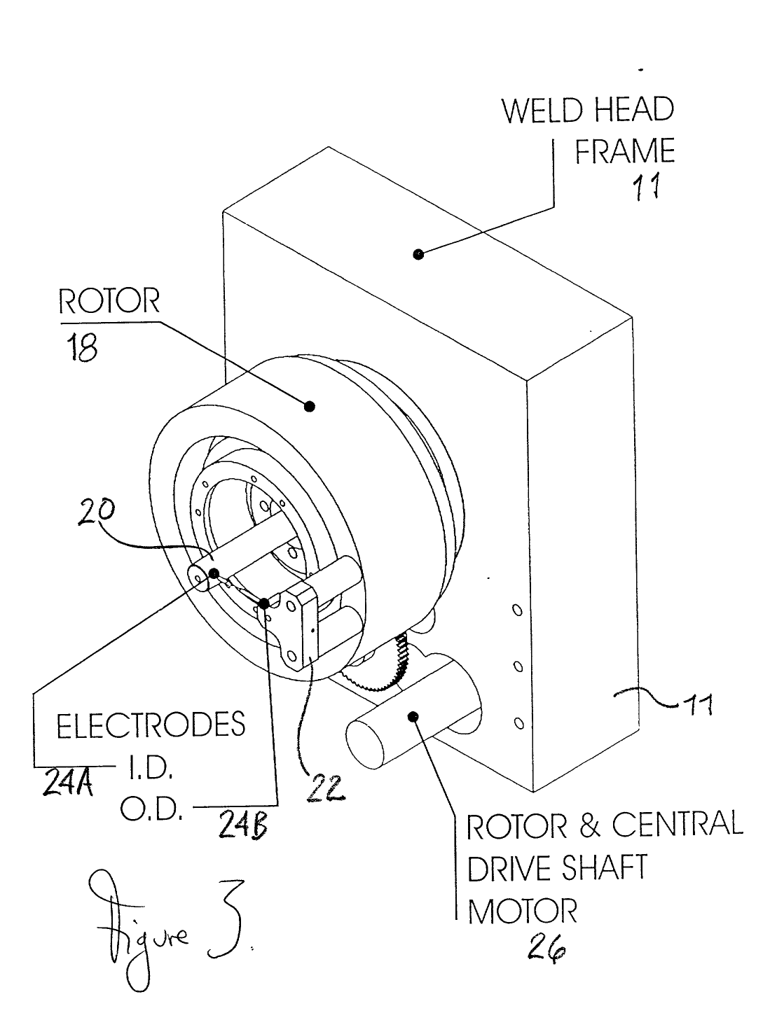

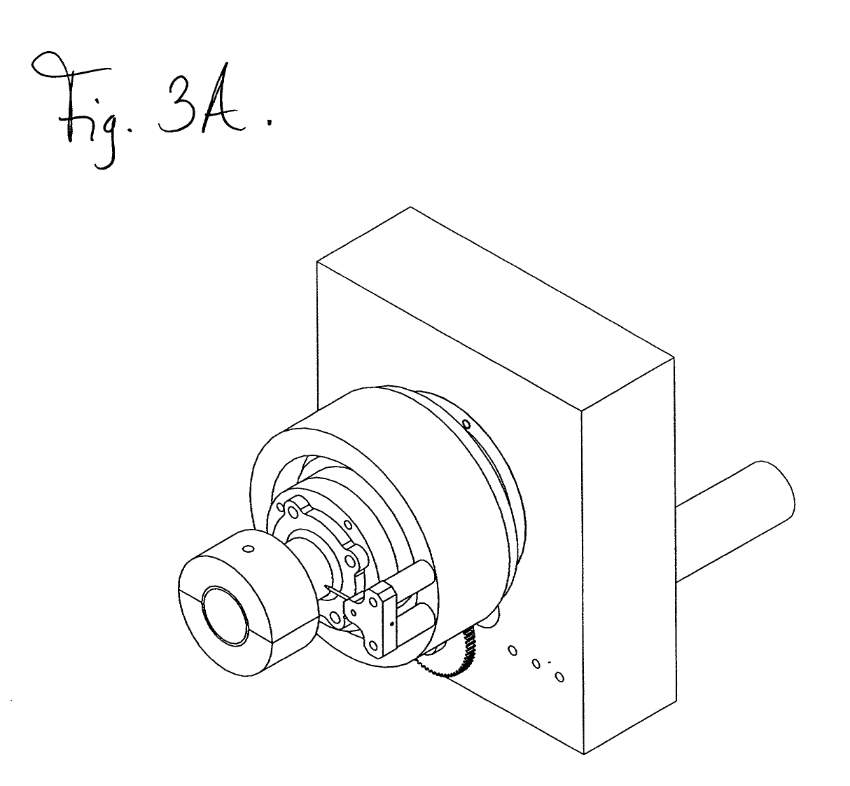

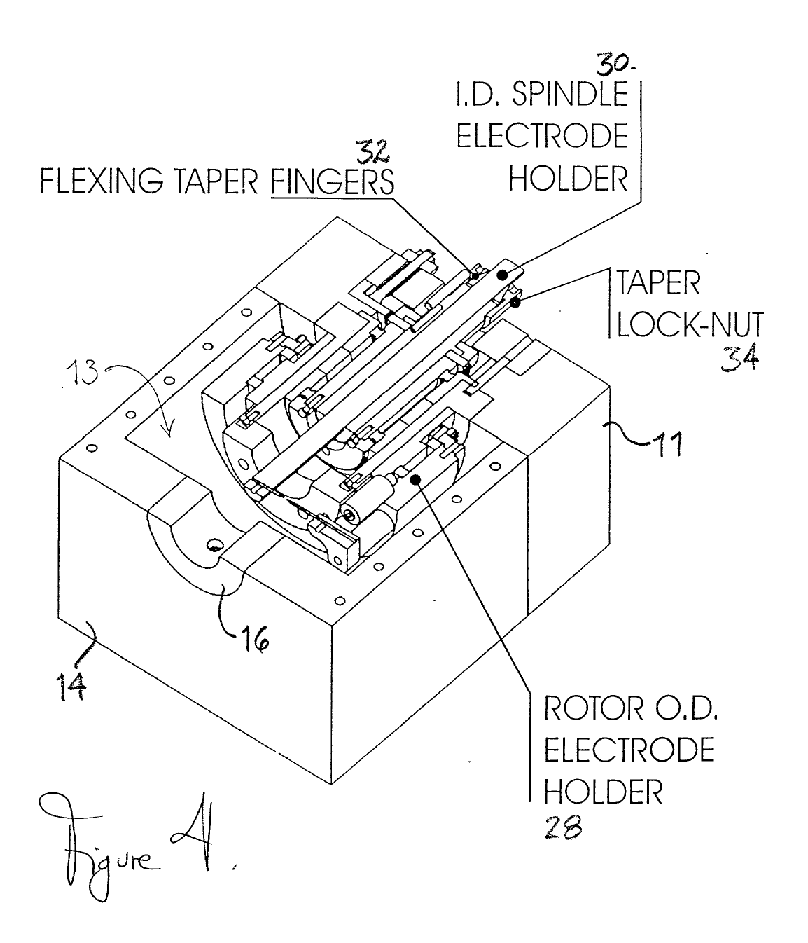

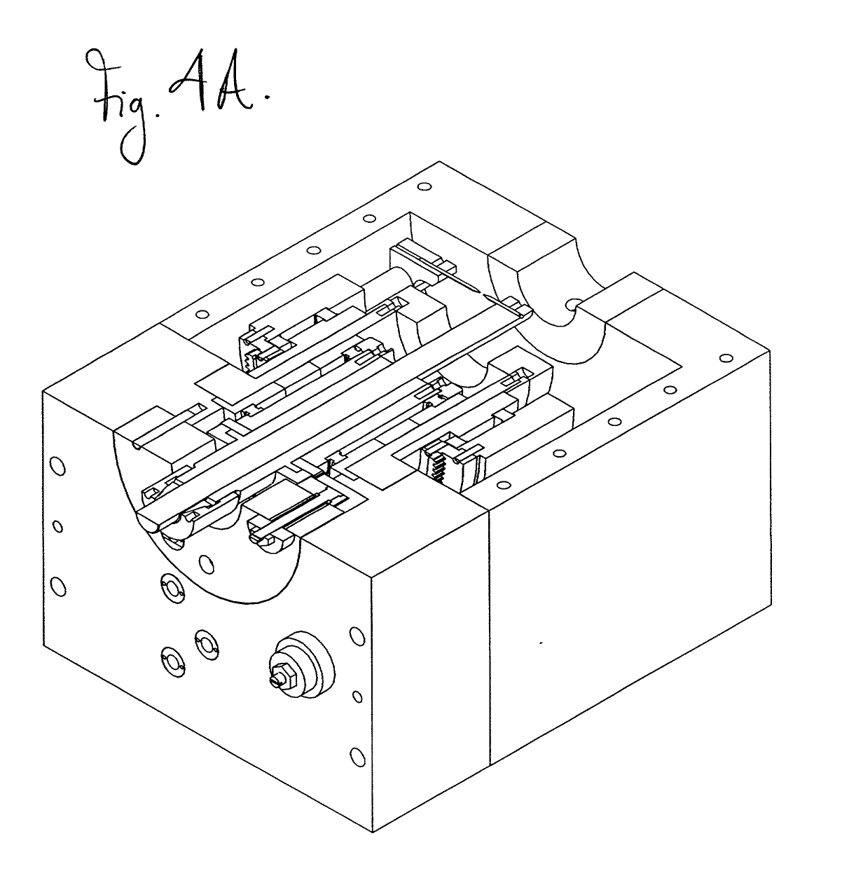

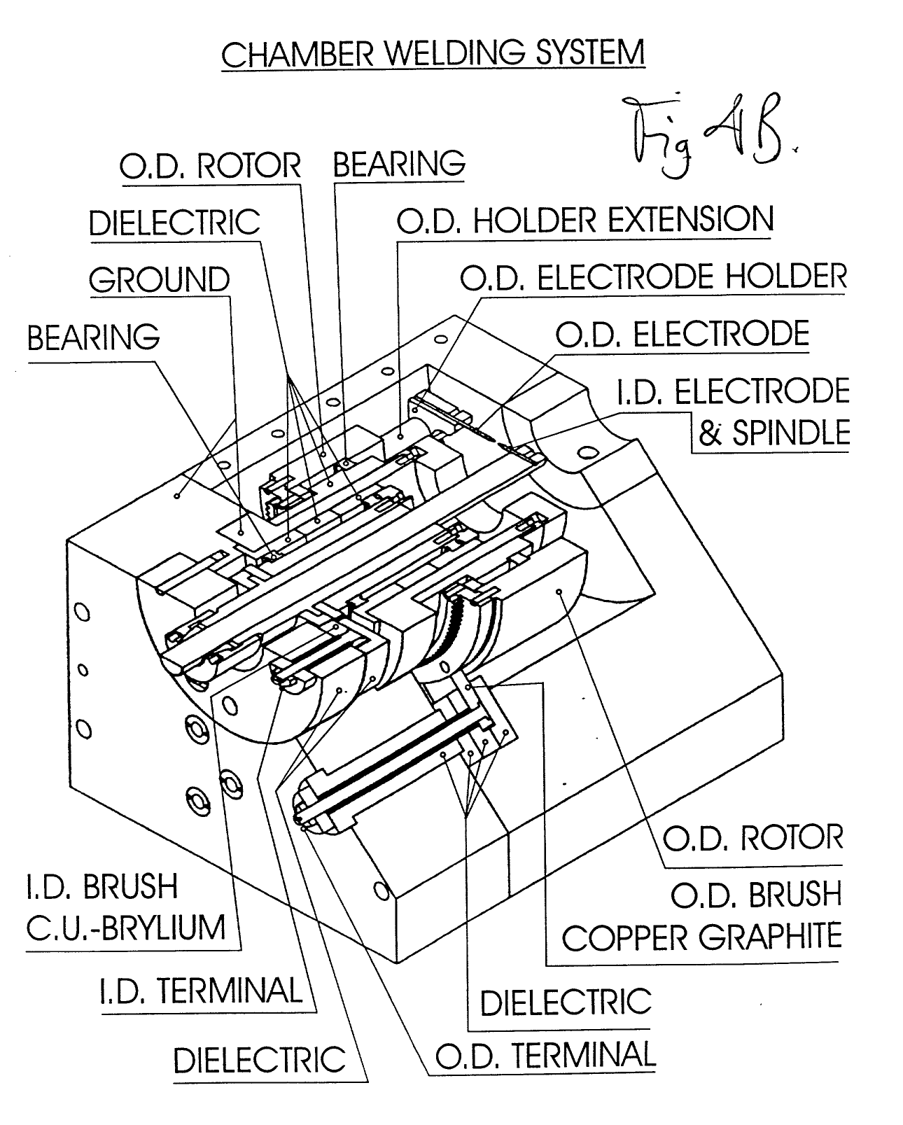

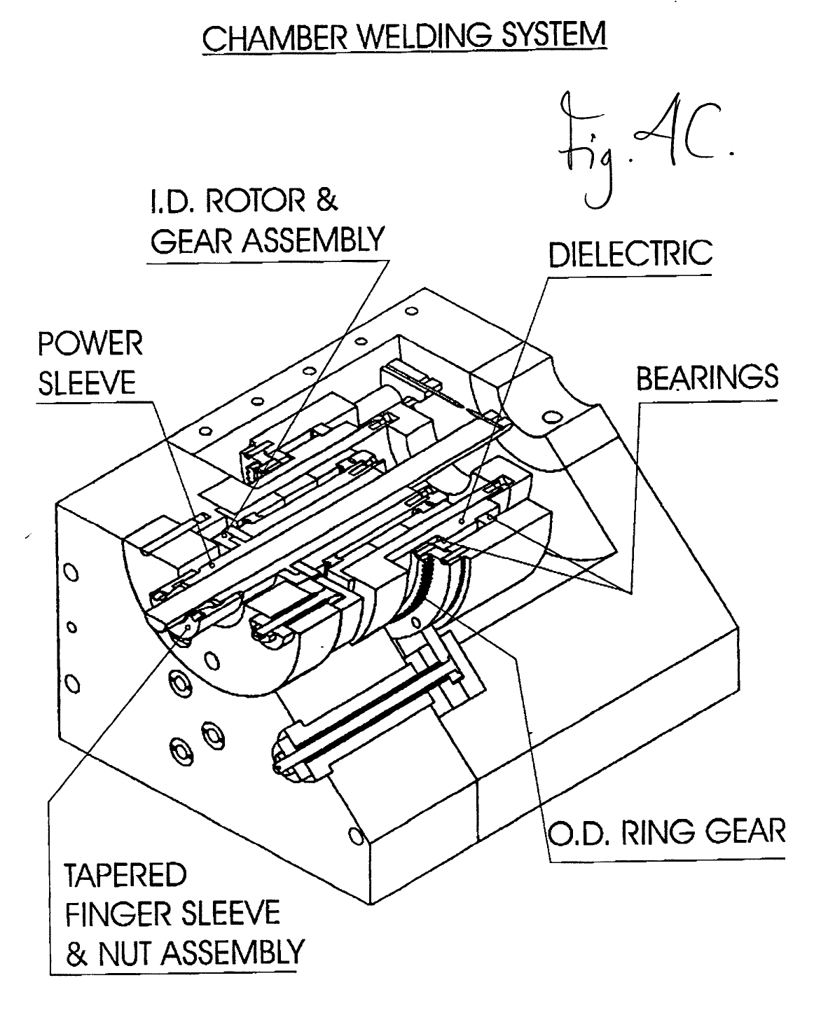

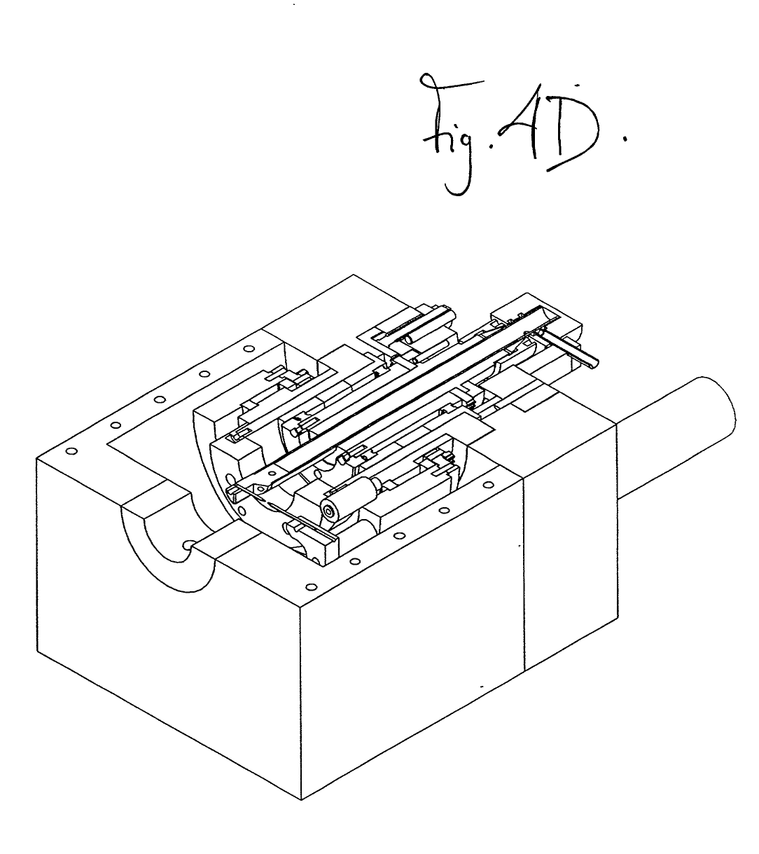

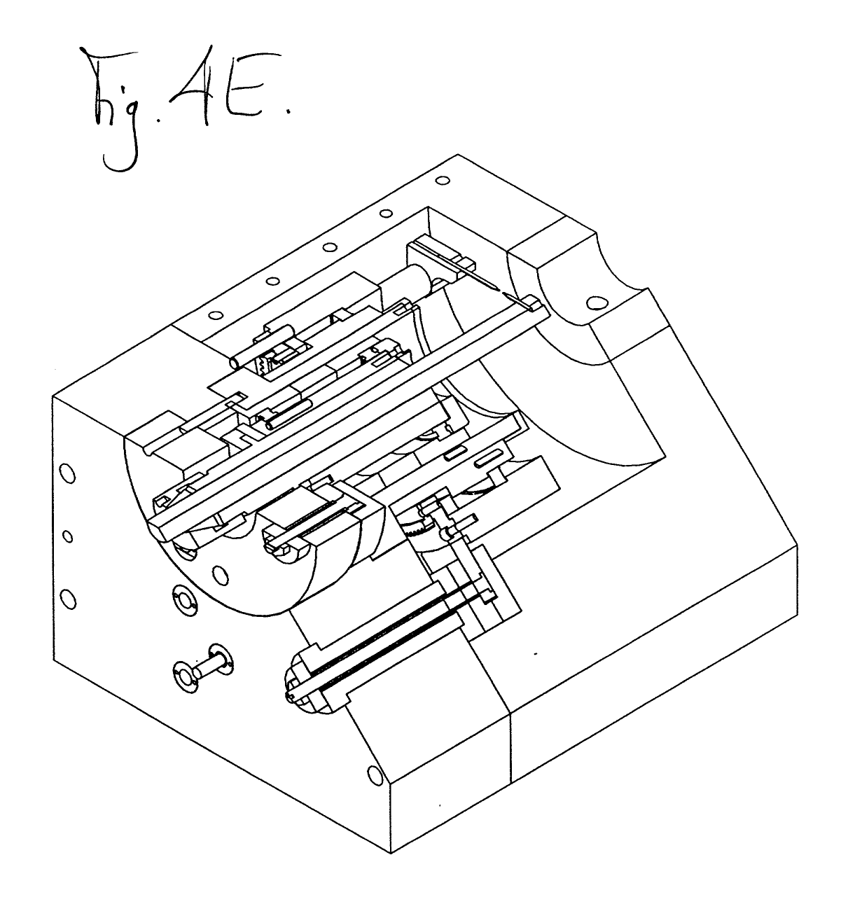

FIGS. 6, 7, 7A, 8, 8A, 8B, 8C and 8D offer views of the interior elements of one embodiment of the invention. These figures illustrate a rotor gear drive 44, a rotor brush 46, an outside diameter rotor brush assembly 48, an idler gear 50, a rotor drive motor pinion gear 52, a rotor ring gear 54, a central shaft gear 56, a central shaft 58, a rotor drive gear 60, idler gears 62, a meshing gear train 64, a drive motor 66 and a drive motor gear 68.

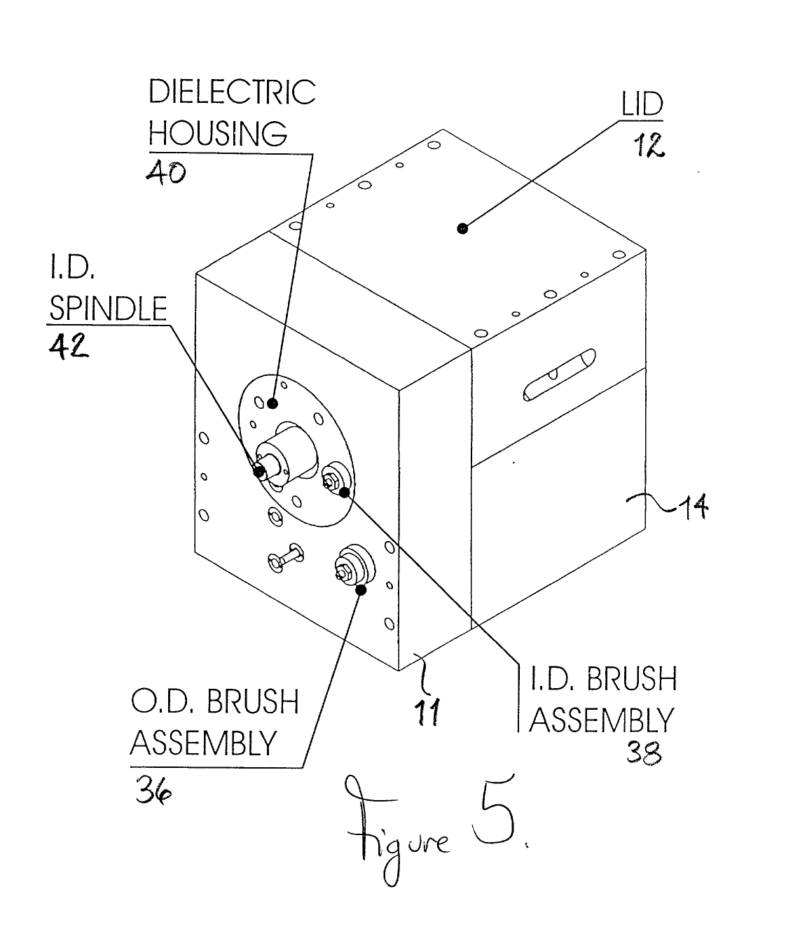

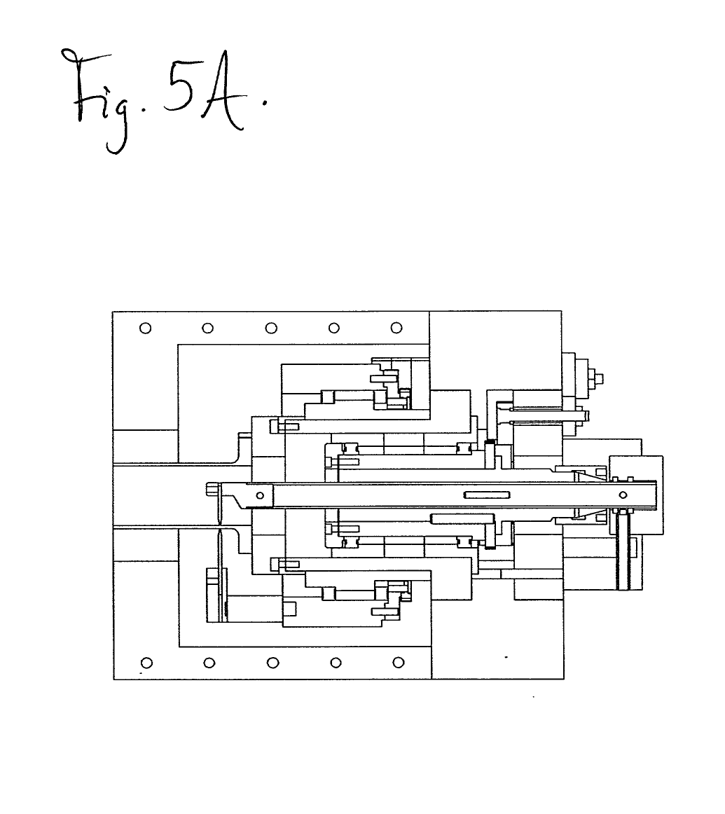

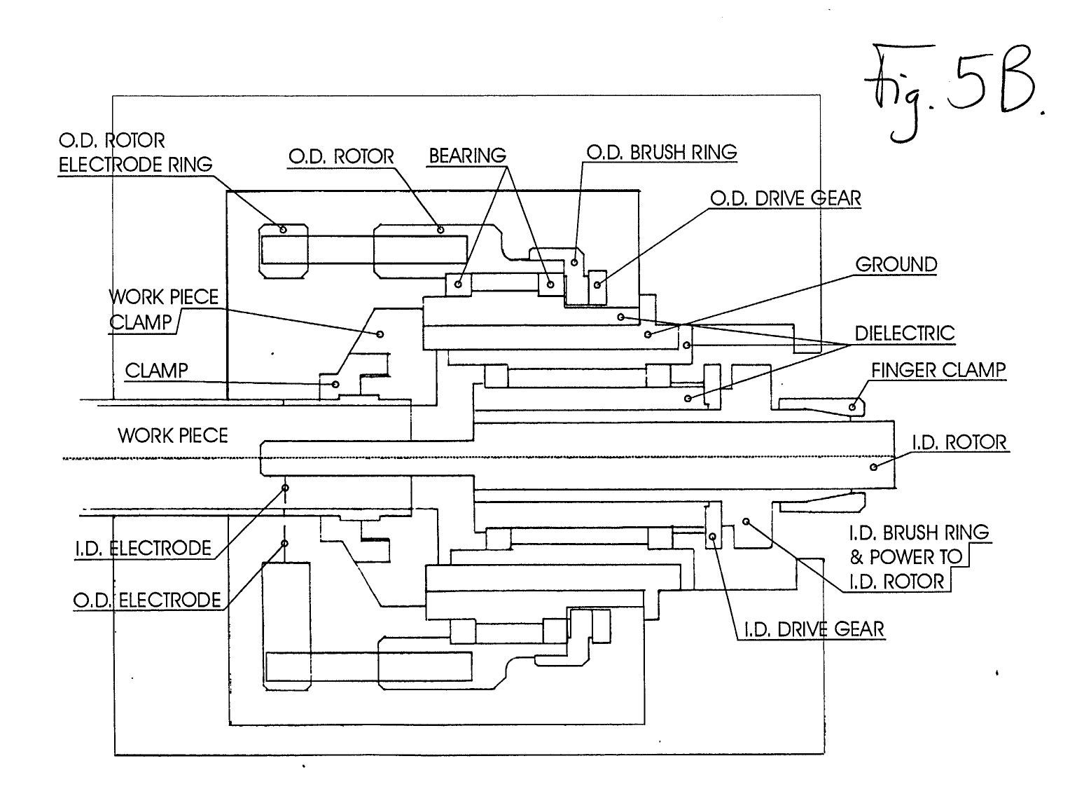

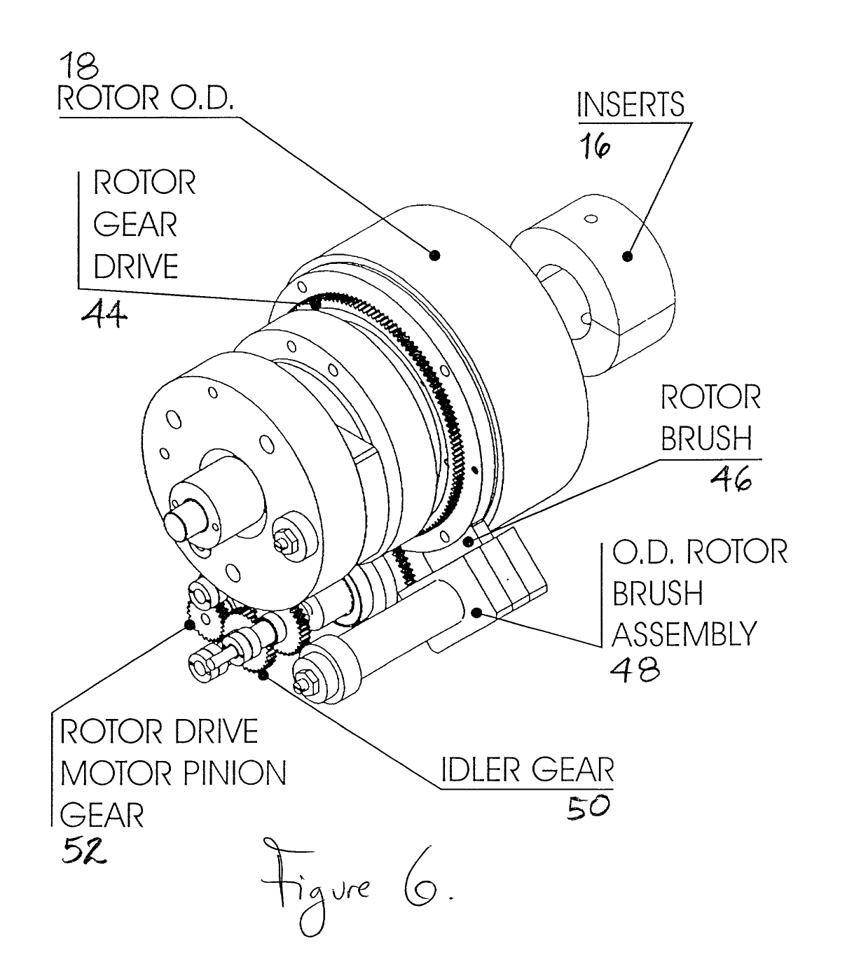

FIG. 9 is a perspective front view of the invention that reveals the weld head rotor and electrodes that occupy the chamber enclosed by the weld head frame, the chamber base and the lid. FIGS. 10, 11 and 11A present views of the interior portions of the invention.

Although one preferred embodiment of the invention uses one inside and one outside electrode (24A & 24B), alternative embodiments of the invention may include any number and any combination of inside and/or outside electrodes. When used in this Specification and in the claims that follow, the term “inside” refers to an electrode or other energy discharging means that supplies energy while it is located inside the chamber 13 and within the internal confines of a workpiece. The term “outside” refers to an electrode or other energy discharging means that supplies energy while it is inside the chamber 13, but located outside the exterior of a workpiece. Although the preferred embodiment of the invention uses gta electrodes, alternative embodiments of the invention may employ plasma heads or any other means which uses energy to enable a welding or joining operation.

The invention includes a gear and power train which provides precise control of the orbital motion of the electrodes. The motion of each electrode is independently controllable, and one electrode may trail another as they move relative to the workpiece. Welding or joining operations may be performed on the inside or outside of a workpiece, or may be performed simultaneously. The number of drive motors used may vary with the complexity of the level of electrode control that is desired.

II. Power Supply

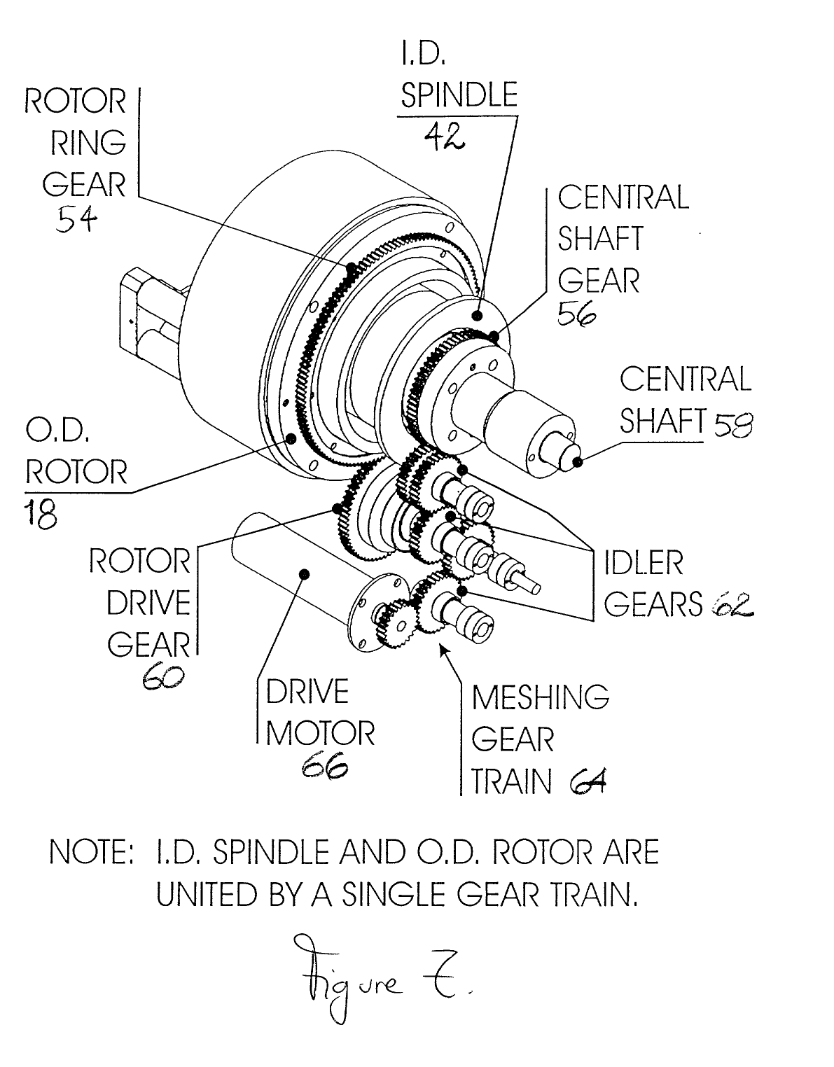

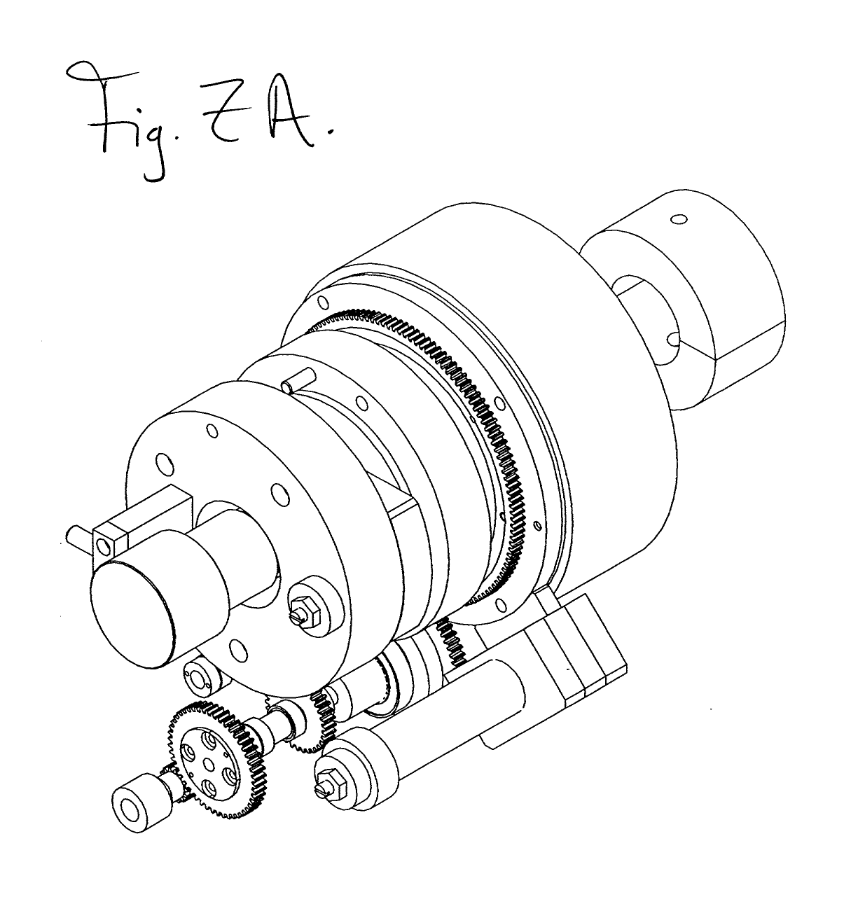

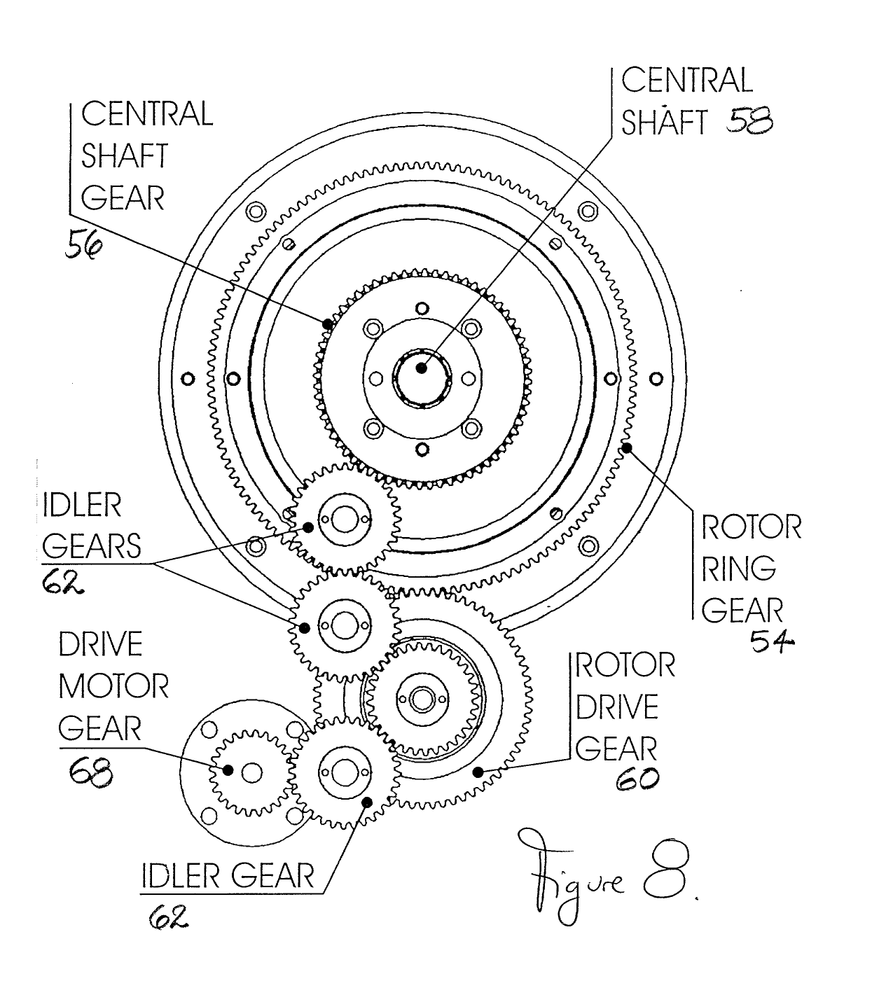

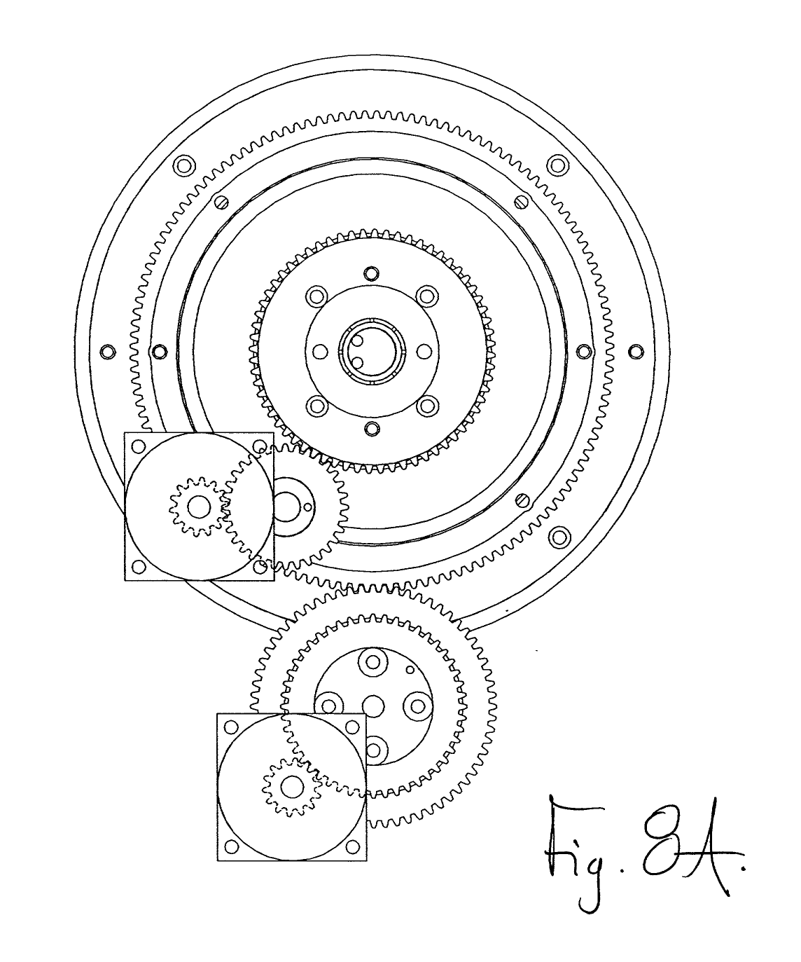

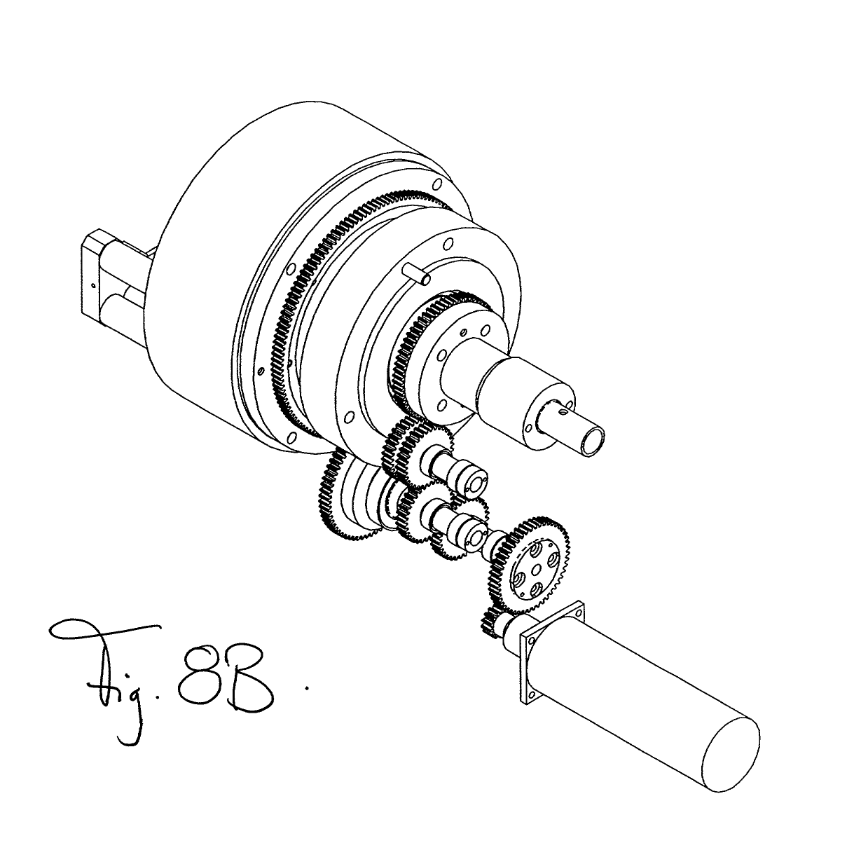

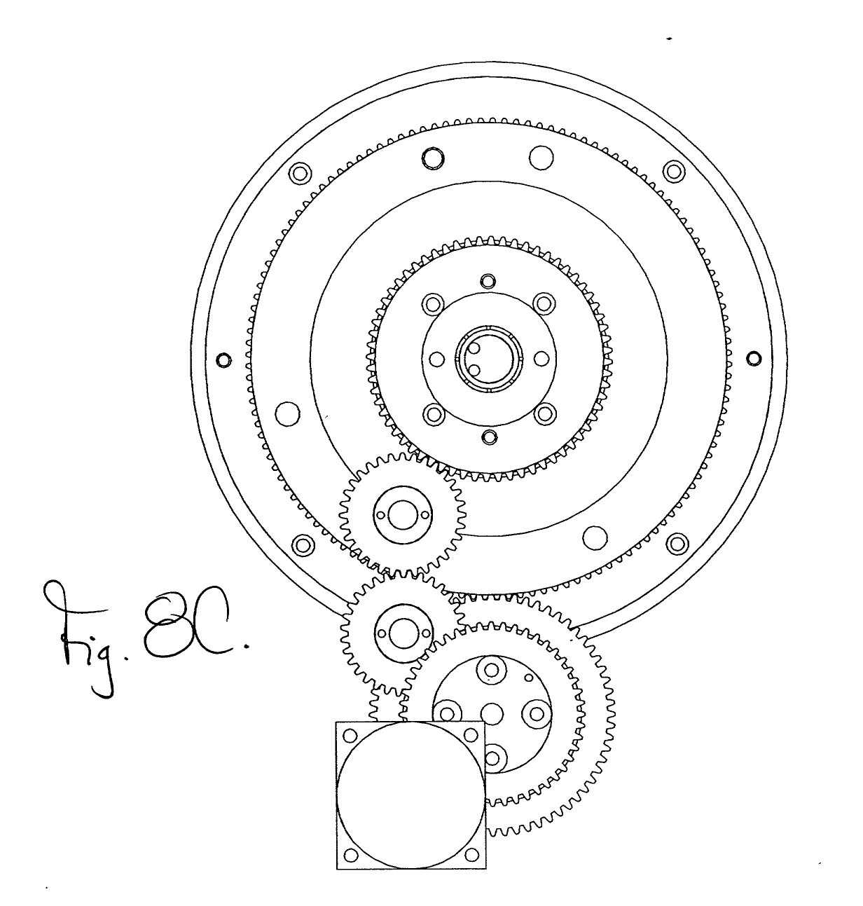

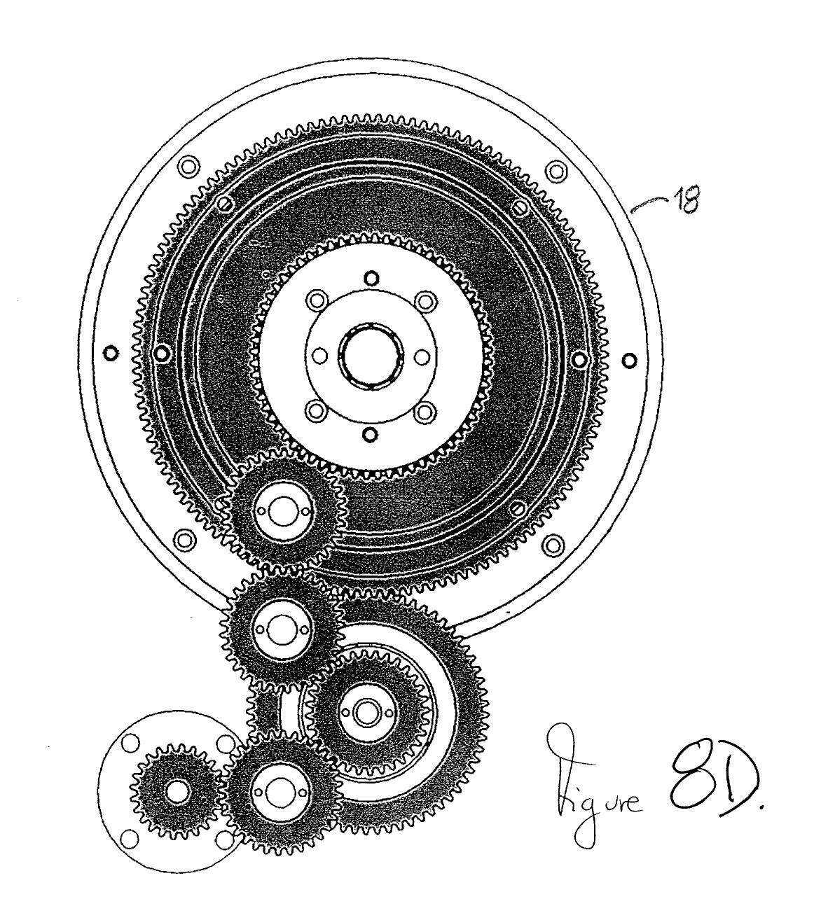

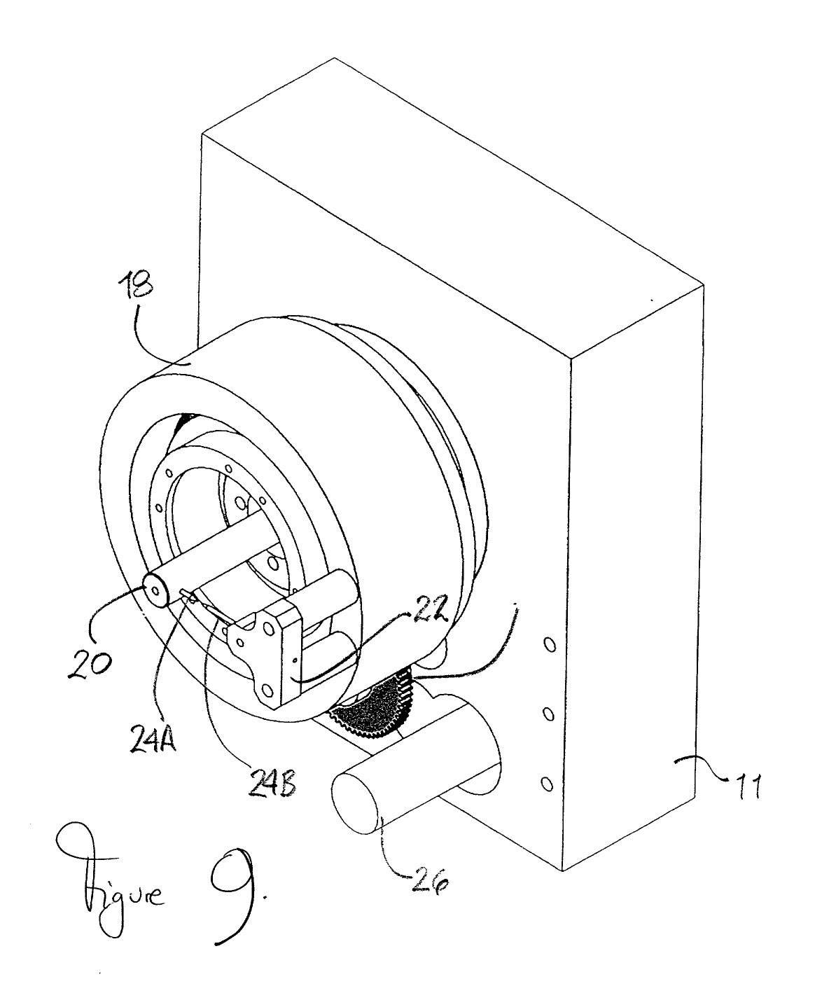

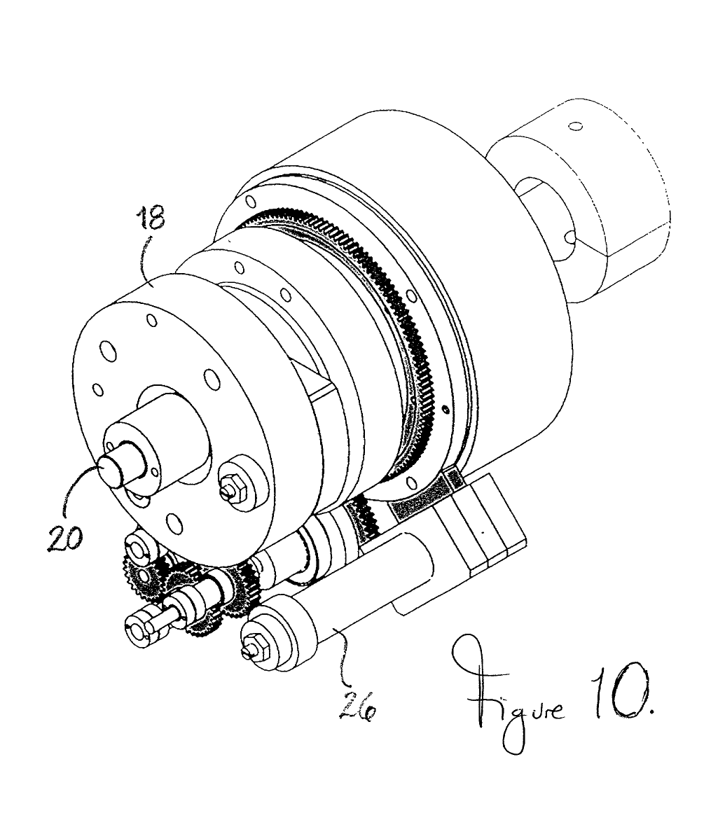

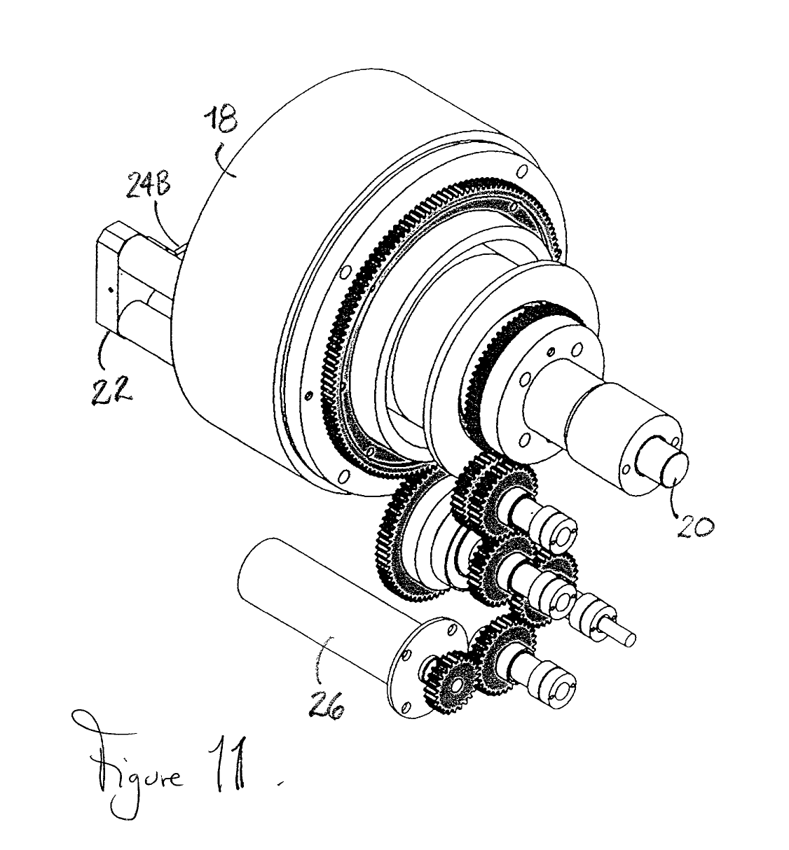

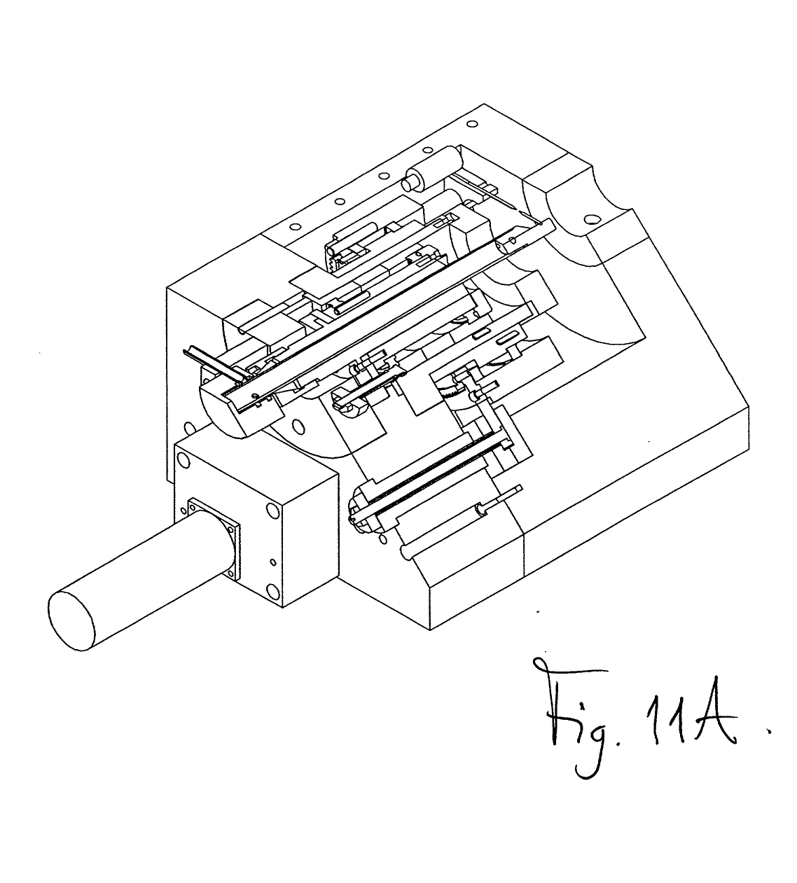

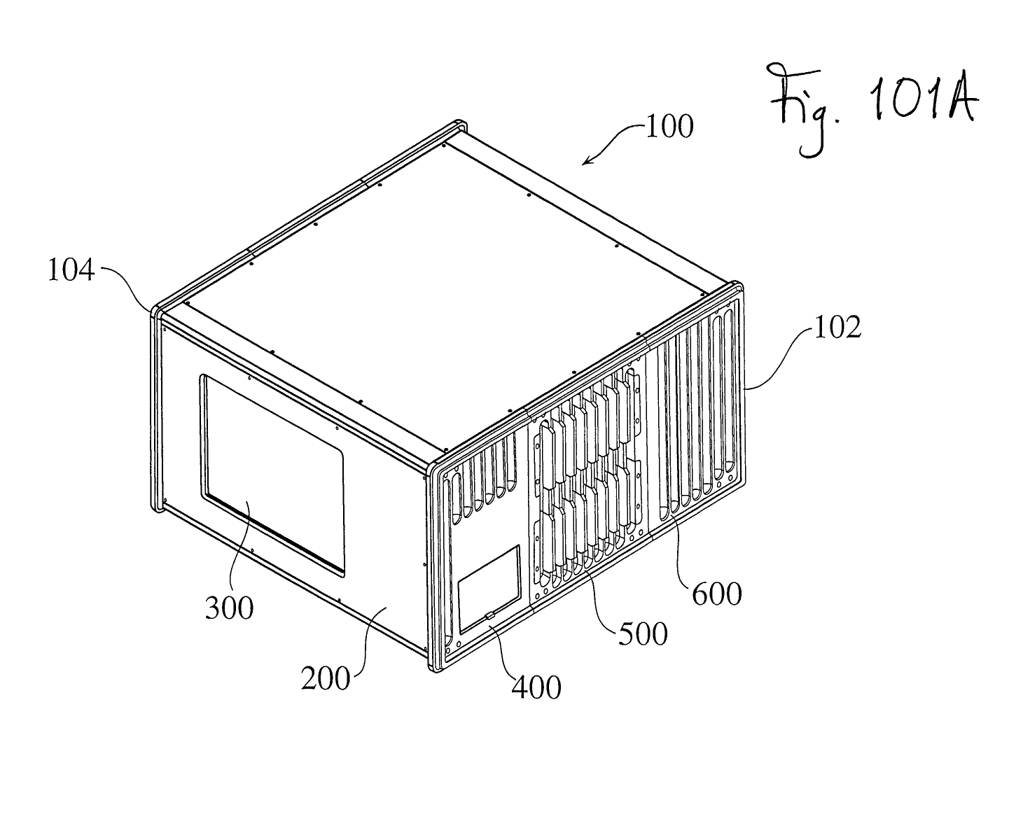

FIG. 101 A is an isometric view of a preferred embodiment of the Computer-Controlled Modular Power Supply for Precision Welding. A miniaturized, lightweight and portable aluminum enclosure 100 comprises rectangular frames 102 and 104 which provide support for the panels held within them. Compared to previous power supplies, the present invention represents a substantial improvement in the amount of space and volume that it occupies. Although the embodiment portrayed in FIG. 10A weighs only about forty-five pounds, it is capable of delivering from 25 to 200 amperes of high quality power for welding tasks. The invention may be used to control welding, induction heating an XY-table or CNC operations. When used to control welding tasks, the Power Supply may be used for longitudinal, multi-head and multi-axes procedures. The present invention may operate twin electrodes simultaneously.

The front panel 200 of the enclosure 100 includes a display with a touch screen 300 that allows the operator of the power supply to control and to monitor its functions. The operation of the power supply may also be monitored remotely using a cathode ray tube display. The embodiment shown in FIG. 1OlA has three modules: a Computer Control Module 400, a Welding Power Module 500 and an Electrical Power Module 600. A carbon steel enclosure 302 which prevents transients from disturbing the operation of the electronic components within the Module 400 resides inside Computer Control Module 400. FIG. 100B offers another isometric view of the enclosure 100, while FIG. 101C reveals a view of the interior 106. Rails 108 span the enclosure's interior 106 and are capable of receiving a variety of modules 400, 500 & 600 into bays 110 within the enclosure 100. Figure lOlD exhibits the side walls of the Computer Control Module 400 and the Welding Power Module 500. The Computer Control Module 400 includes a computer peripheral panel 402. This panel furnishes external coupling hardware, including PCMCIA and remote display couplers; serial ports for connections to pointing devices, keyboards and modems; and parallel ports for connections to printers.

FIGS. 101E through 101I present detailed views of the components of the power supply enclosure 100. Any number or combination of similar or different modules may be inserted into the enclosure. This modular design offers maximum flexibility and versatility to the customer, and is especially valuable when individual parts of the welding power supply need to be maintained, tested, repaired or replaced.

In the preferred embodiment of the invention, the Welding Power Module 500 comprises four drawers 502 which each contain an individual power unit. Although one embodiment utilizes four drawers 502, the invention provides for many alternative configuration of a wide variety of different sized drawers. The outside walls of each of the drawers 502 the Welding Power Module 500 have a number of deep cut heat dissipating fins 504. Unlike previous conventional power supplies which utilize heat sinks and fins located inside the power supply enclosure, the present invention has fins 504 on the exterior of the enclosure 100. Heat produced by each of the drawers 502 is released by both conduction, convection and radiant cooling. These fins 504, which are integrally formed on the drawers 502, help the enclosure 100 to function as a very large heat sink. This innovative feature eliminates the need for cooling fans or vents, which would introduce dust, dirt and moisture into the environment within the enclosure. By keeping the Power Supply free from this contamination, the reliability and performance of the internal electronic components are greatly enhanced.

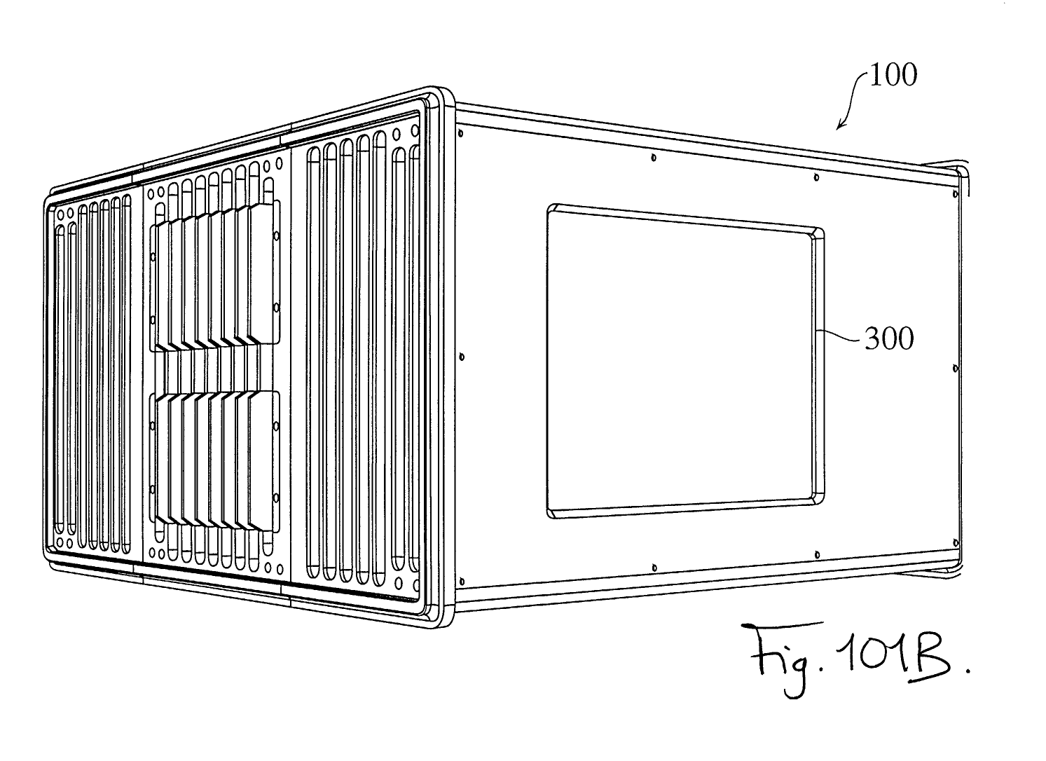

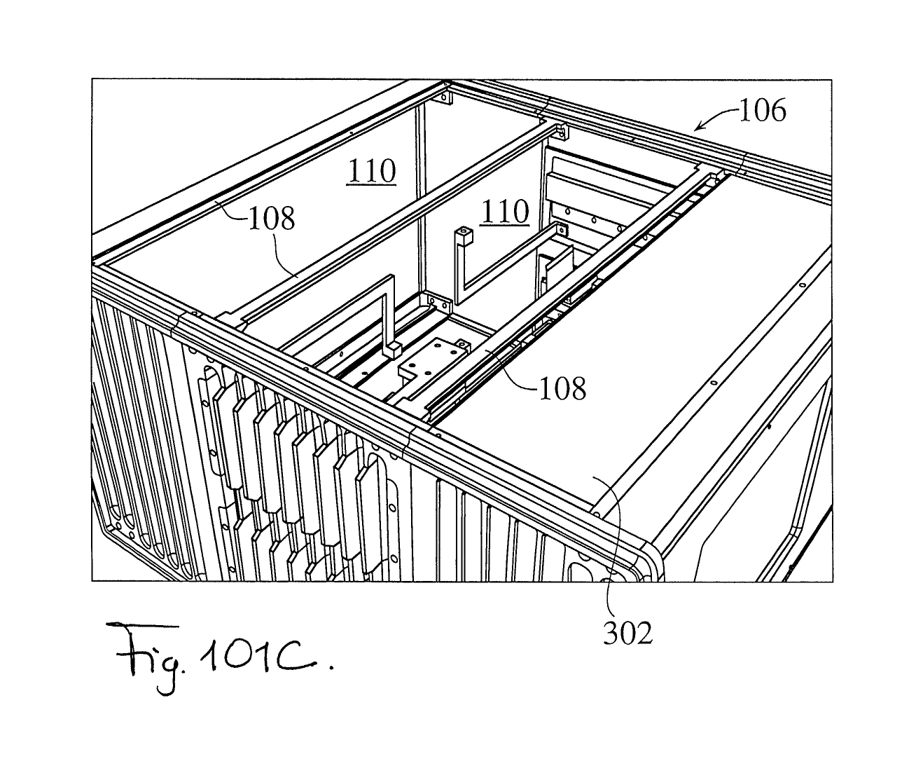

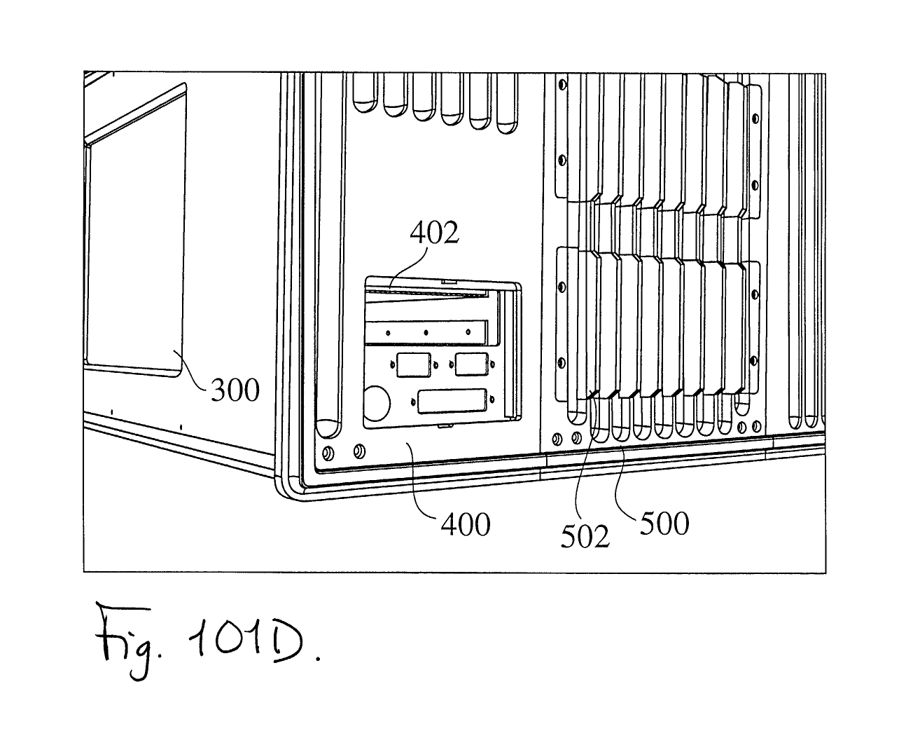

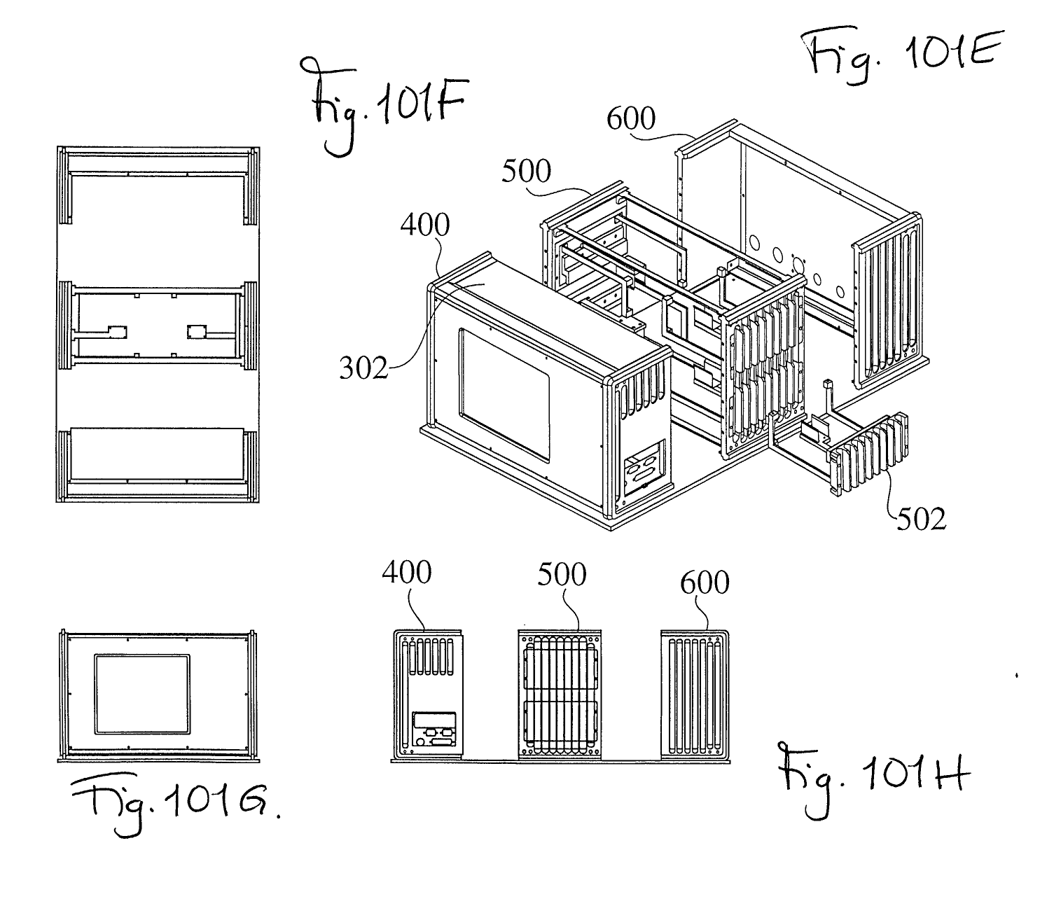

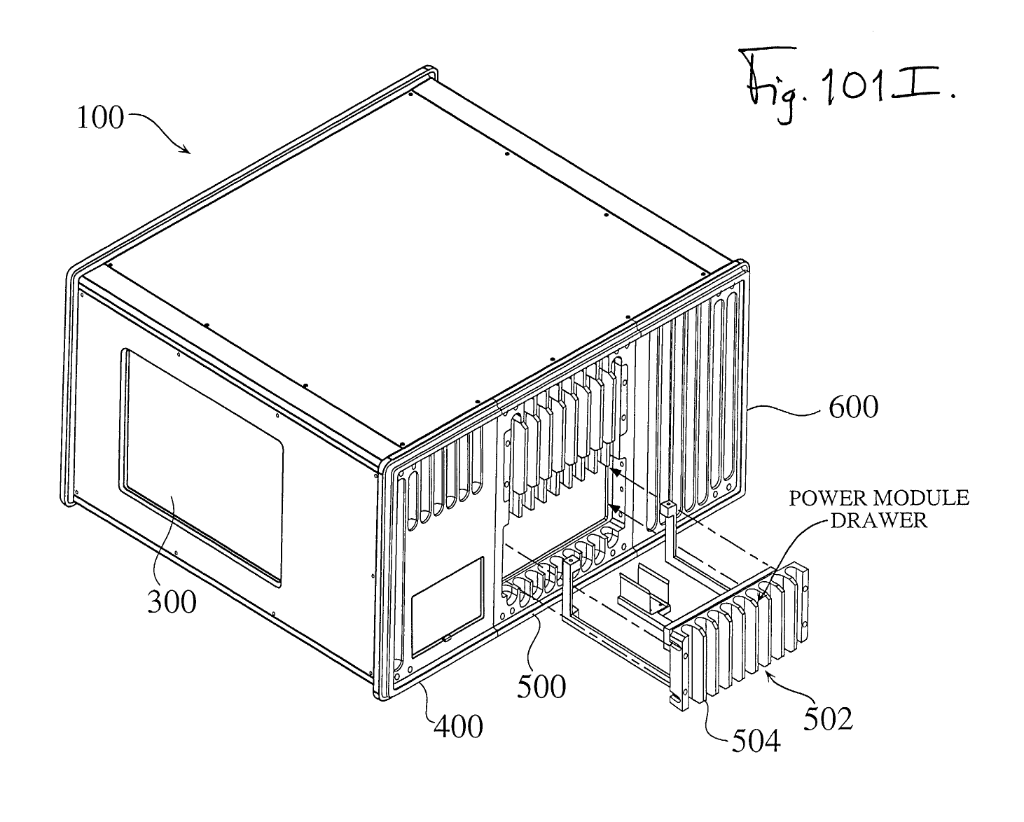

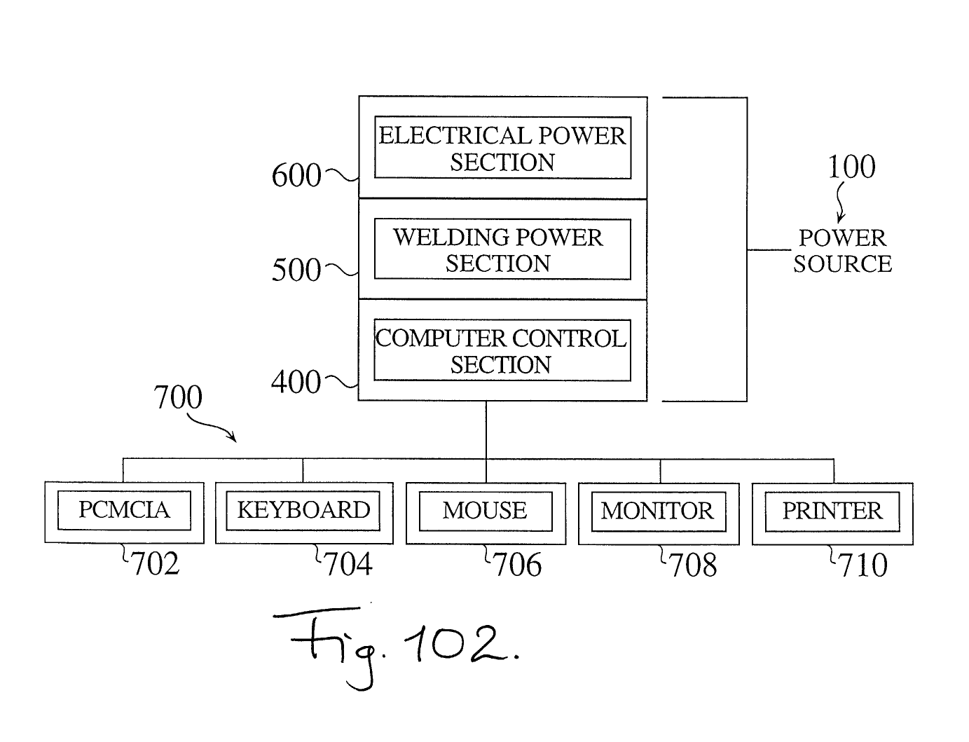

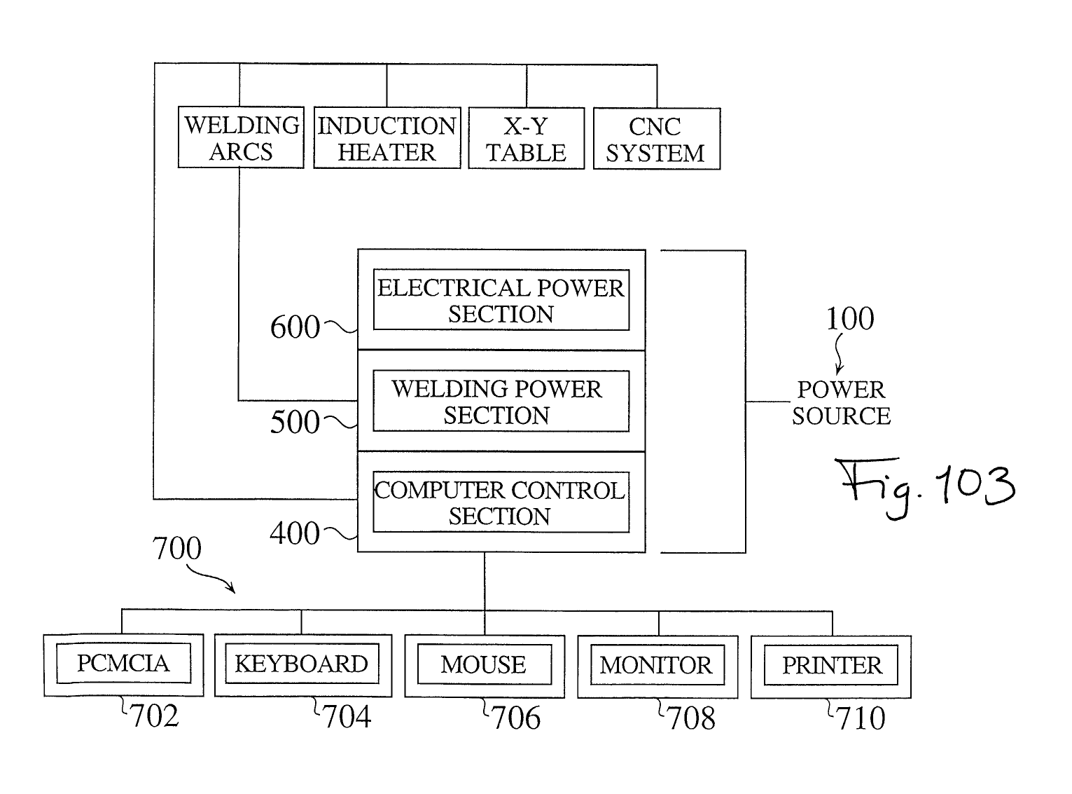

FIGS. 102 and 103 are block diagrams that reveal the functional capabilities of the present invention and the many possible connections to input, storage and peripheral devices 700. In one embodiment of the invention, the Computer Control Module 400 includes a ports for a PCMCIA connector 702, a keyboard 704, a pointing device or mouse 706, an external monitor 708 and a printer 710.

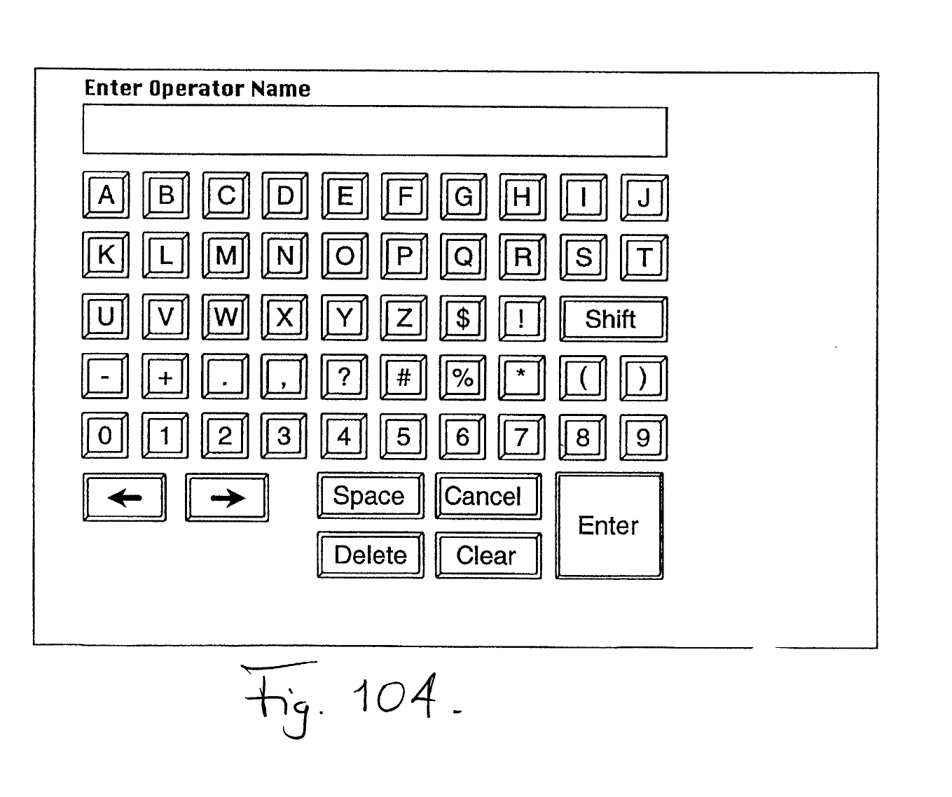

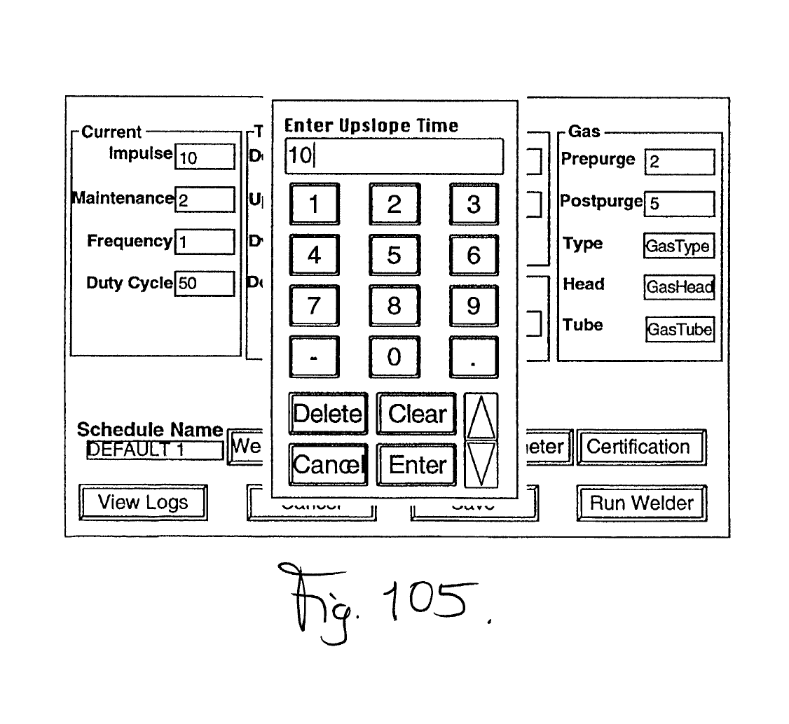

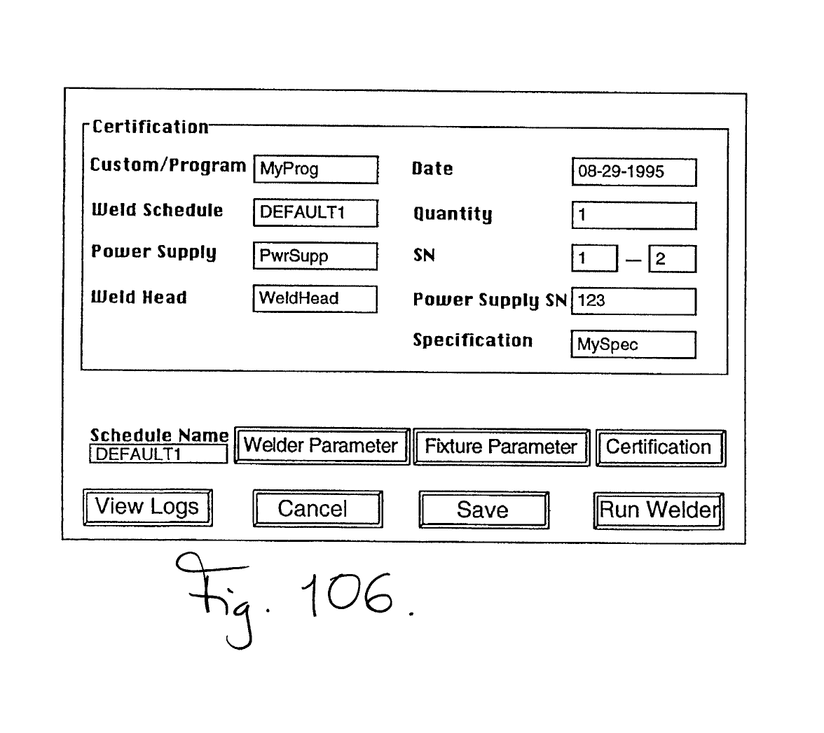

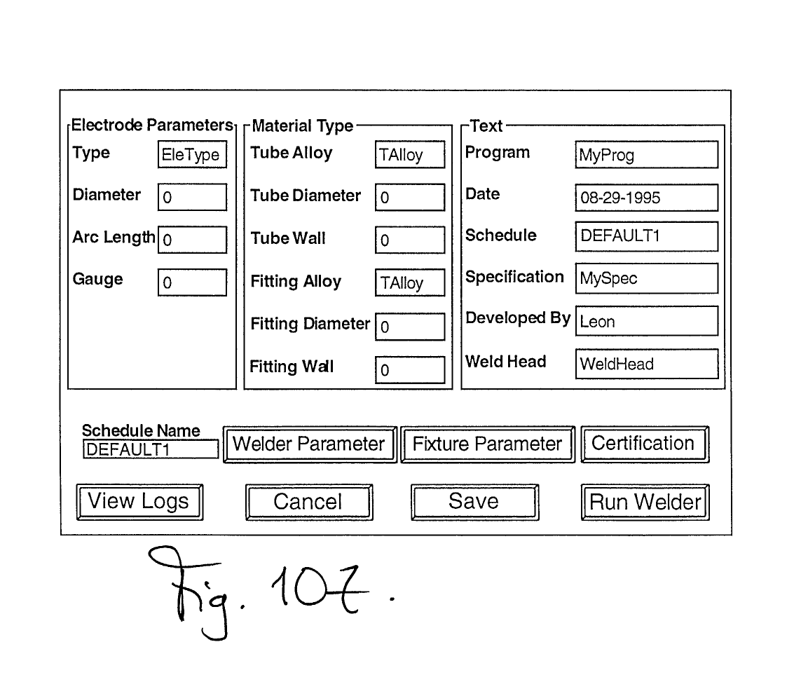

FIGS. 104, 105, 106, 107, 108, 109, 110, 111 and 112 are reproductions of photographs of the output of the LCD with a touch screen. This sequence of drawings illustrates the easy-to-use computer program which provides precise and automatic control of the present invention.

Computer Control Module 400

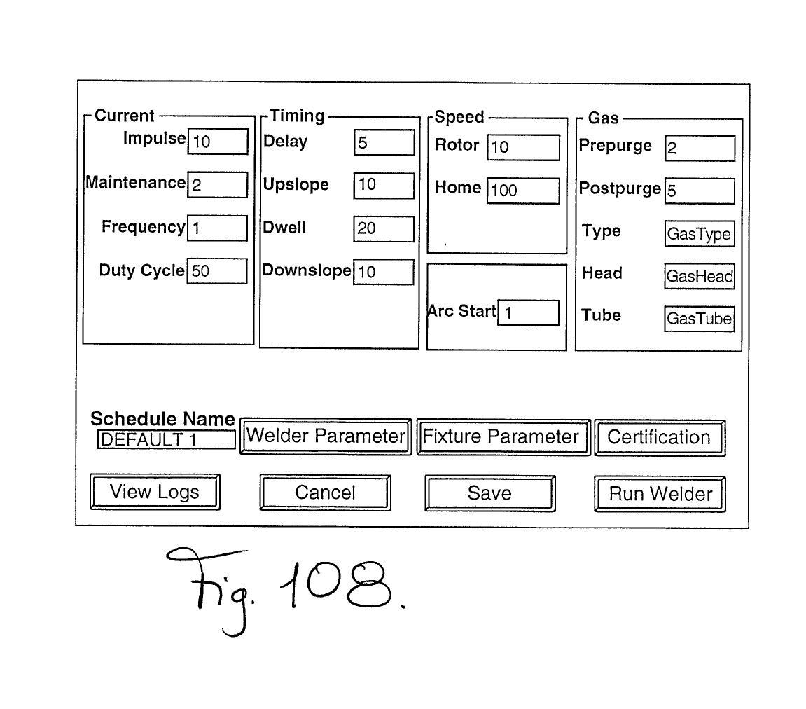

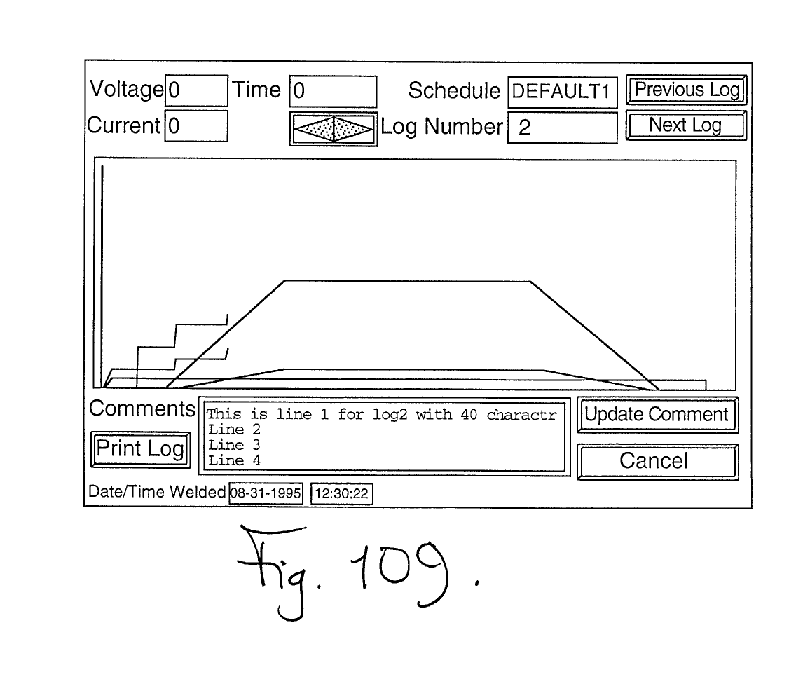

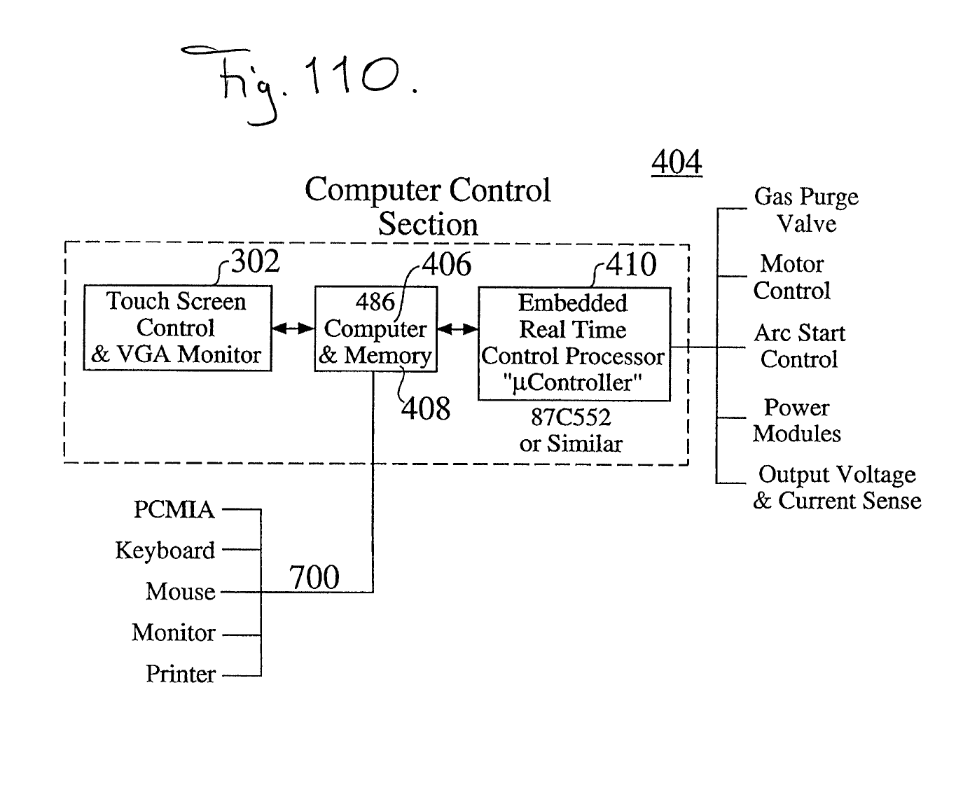

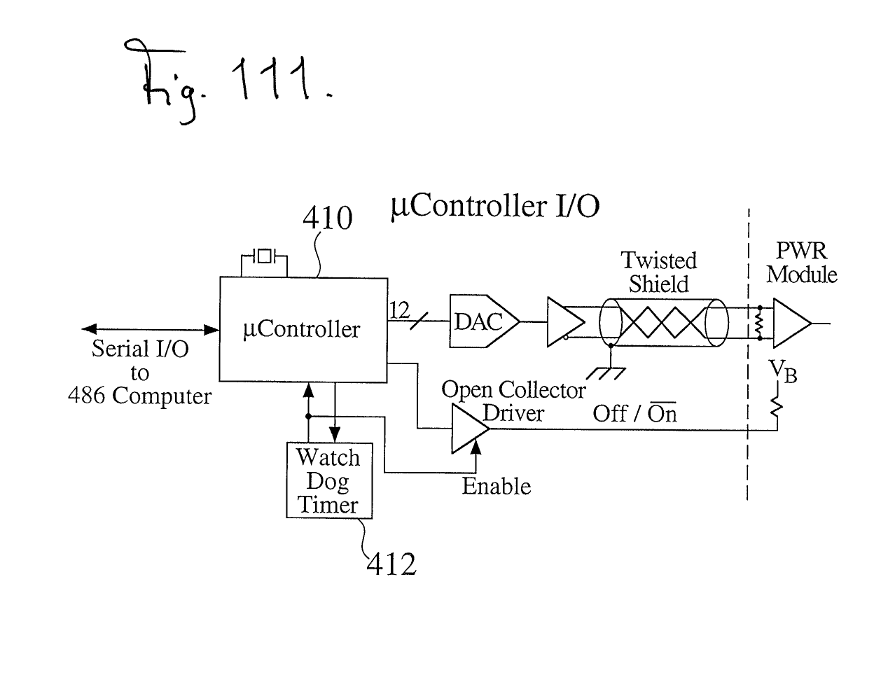

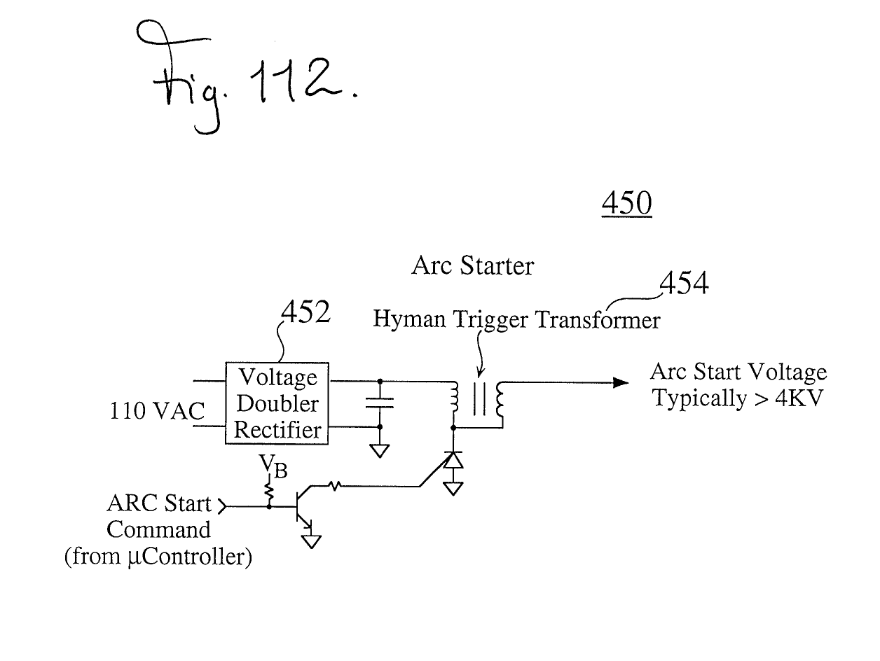

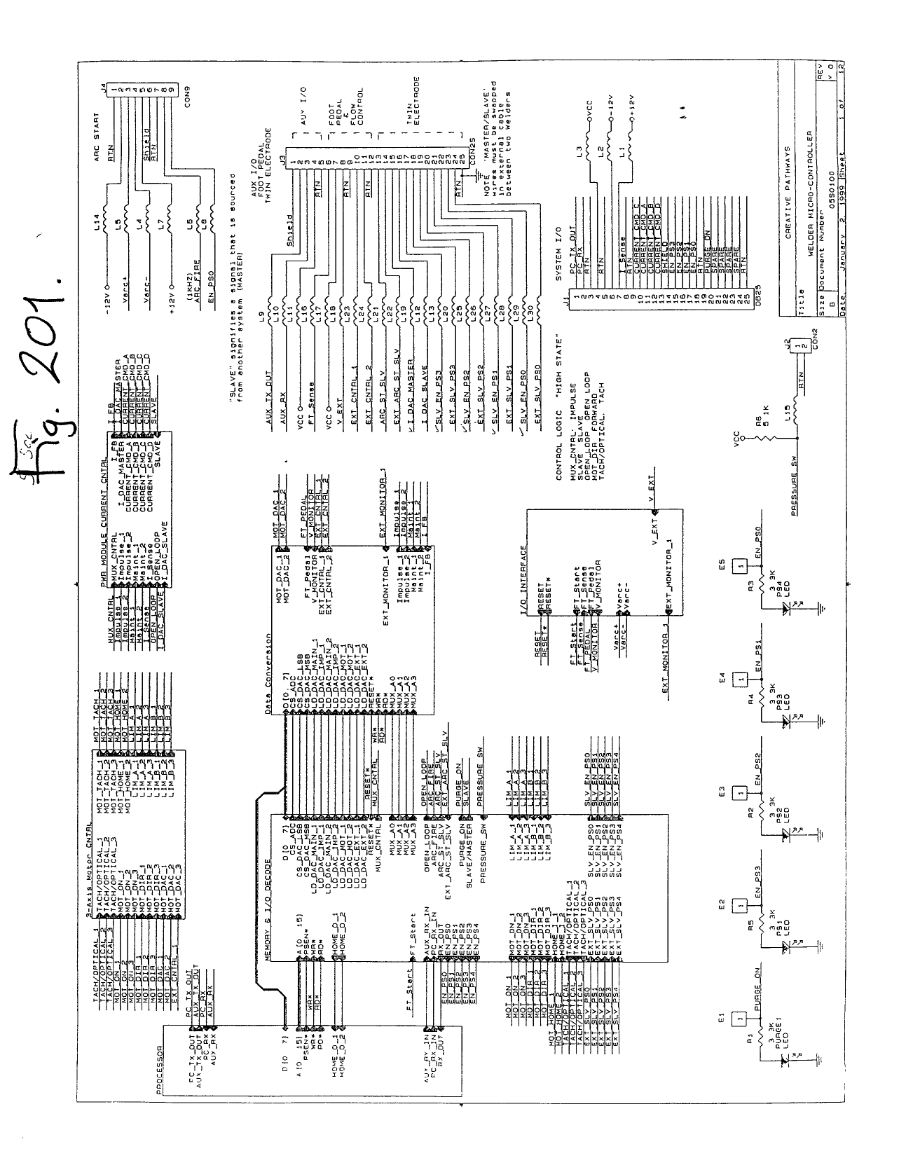

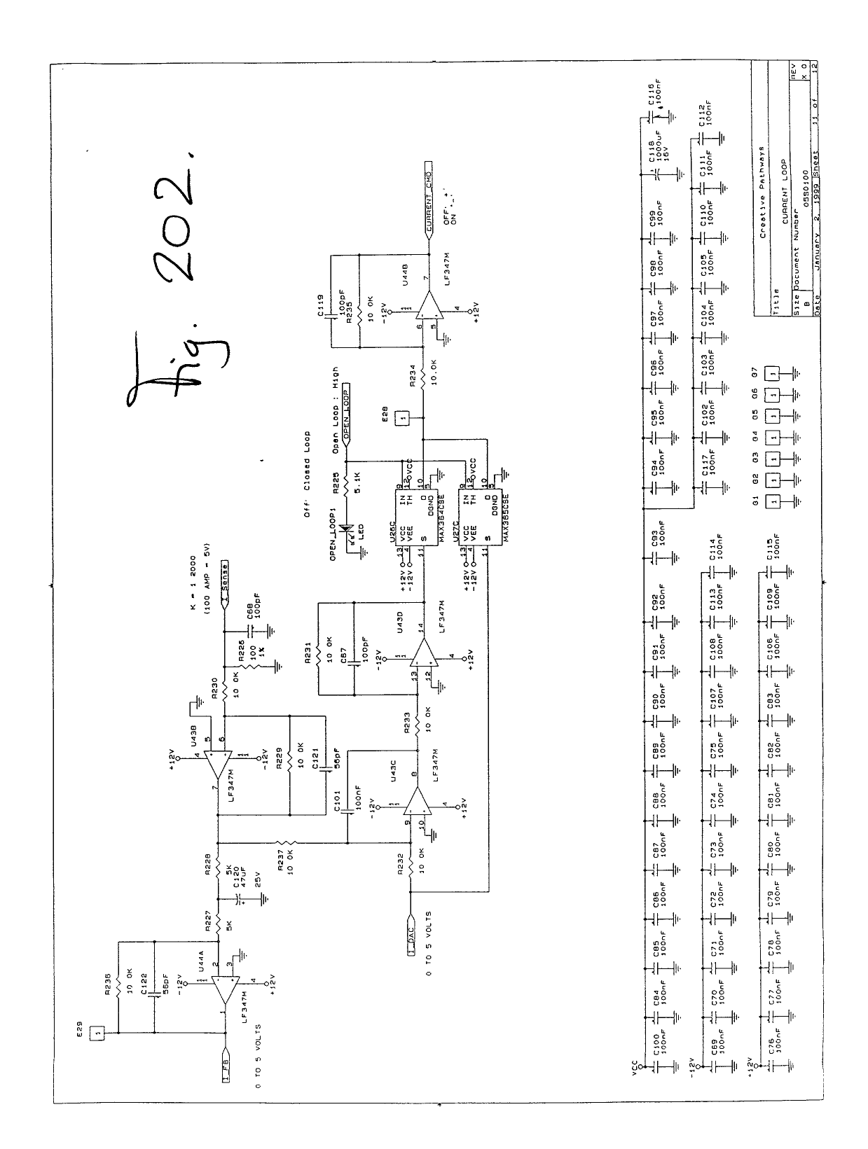

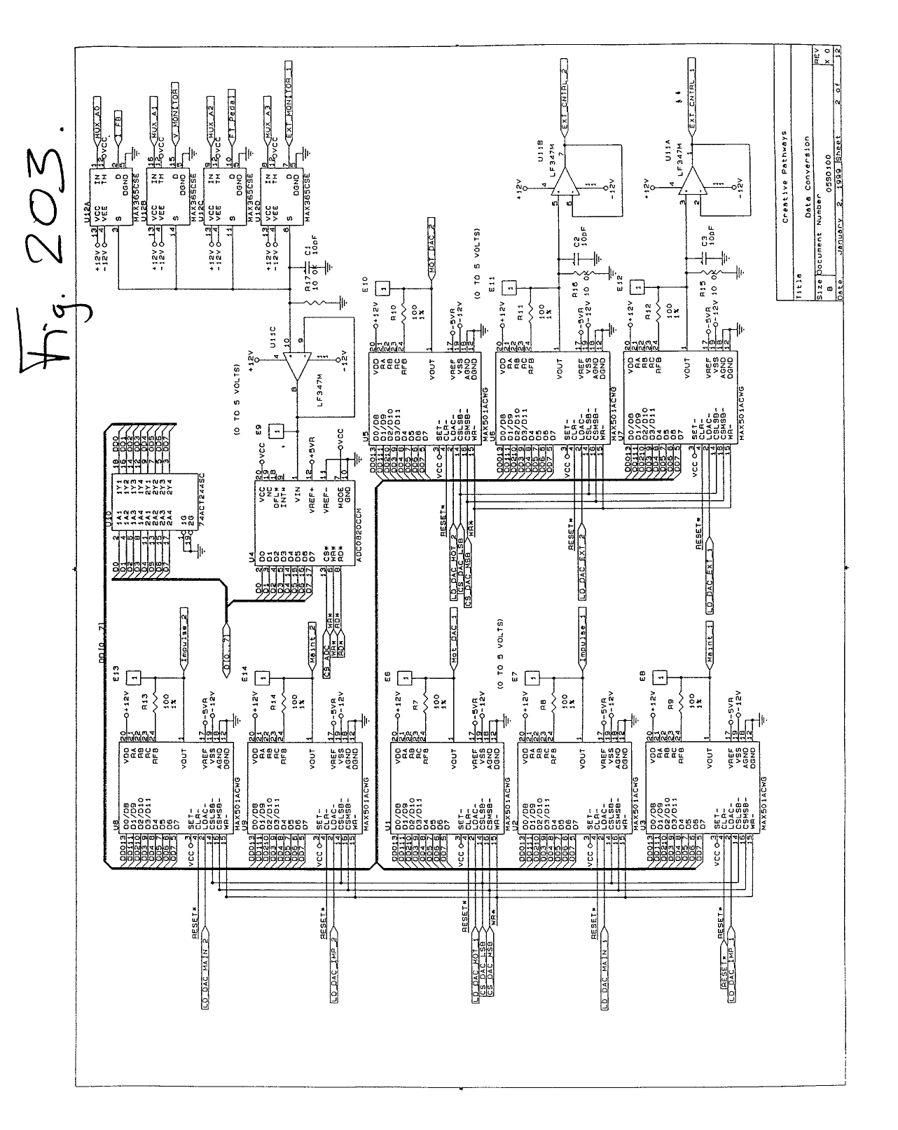

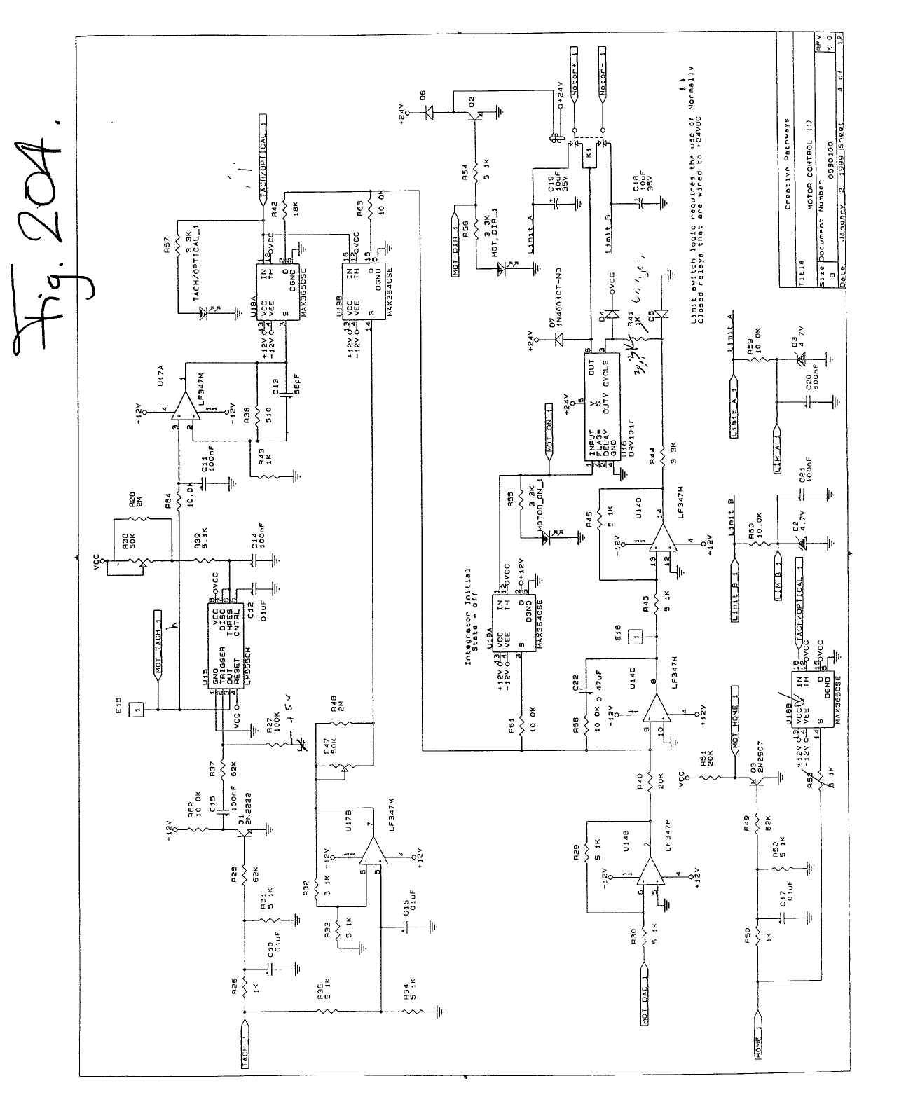

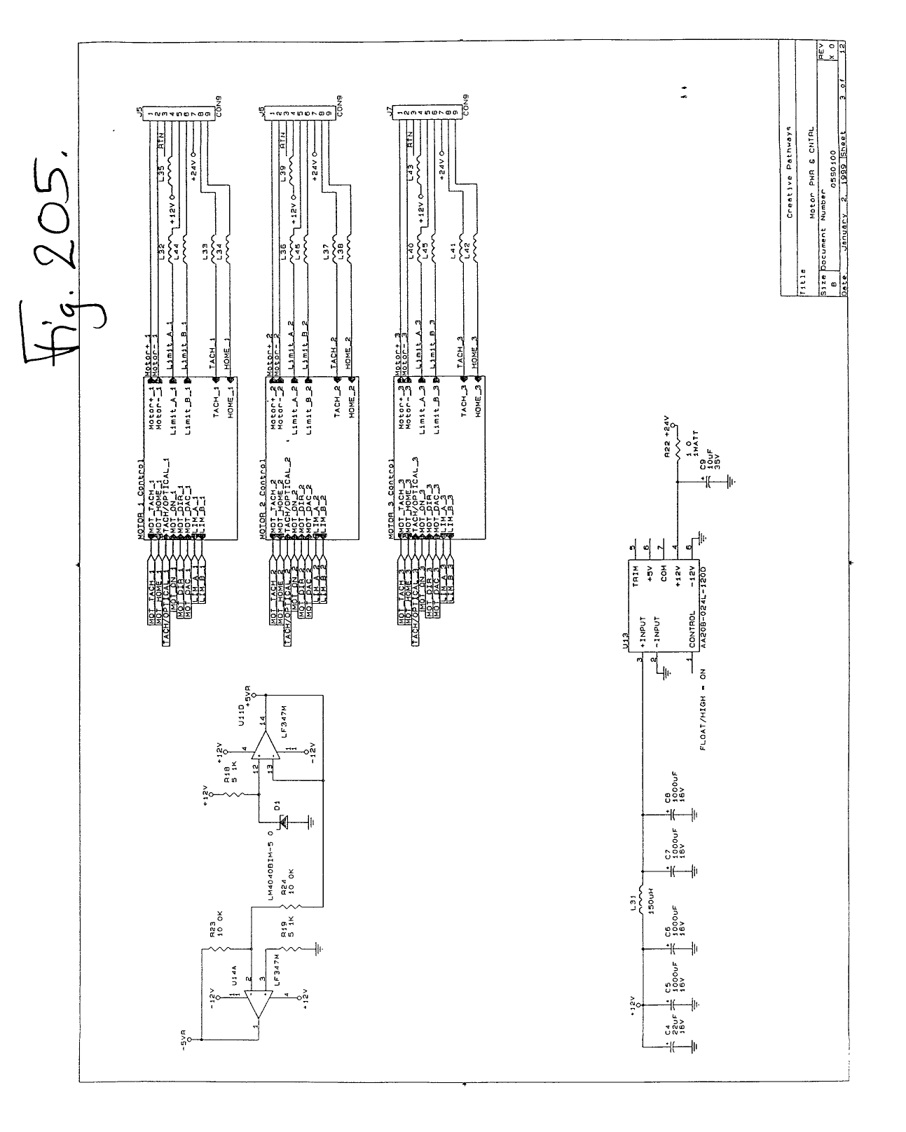

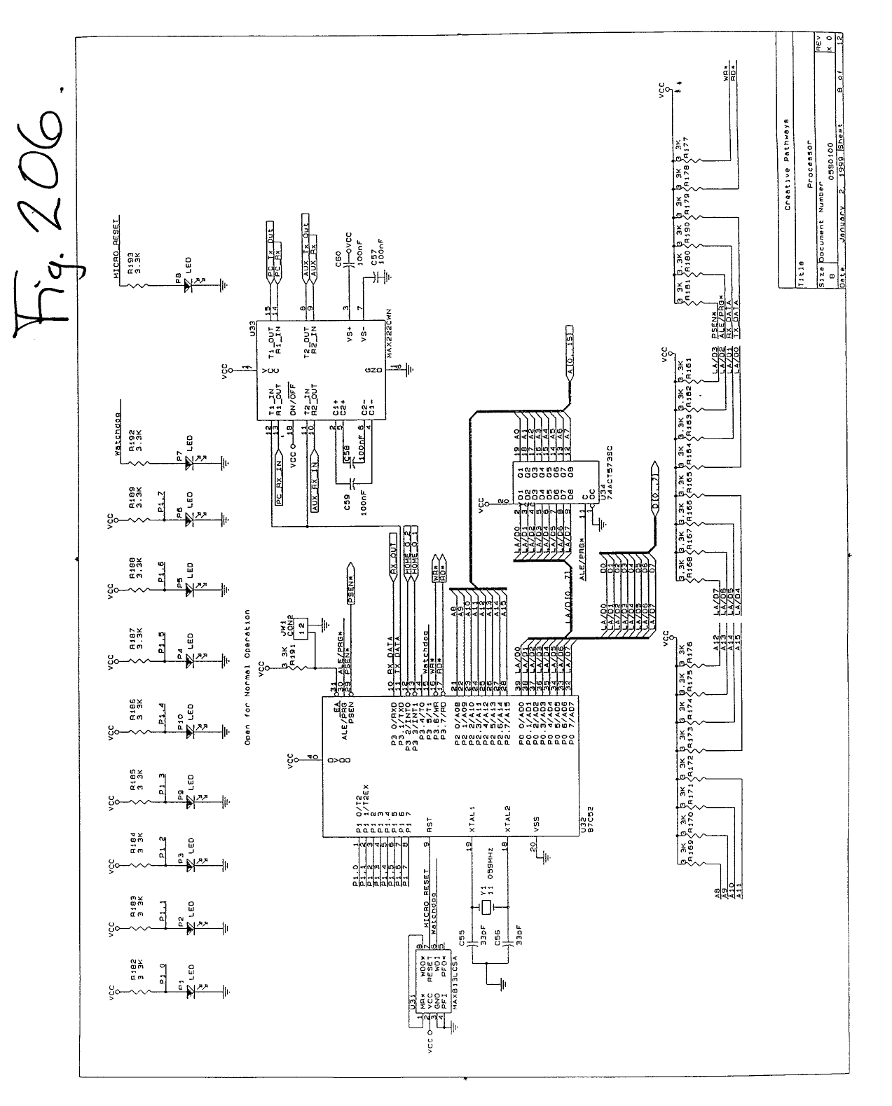

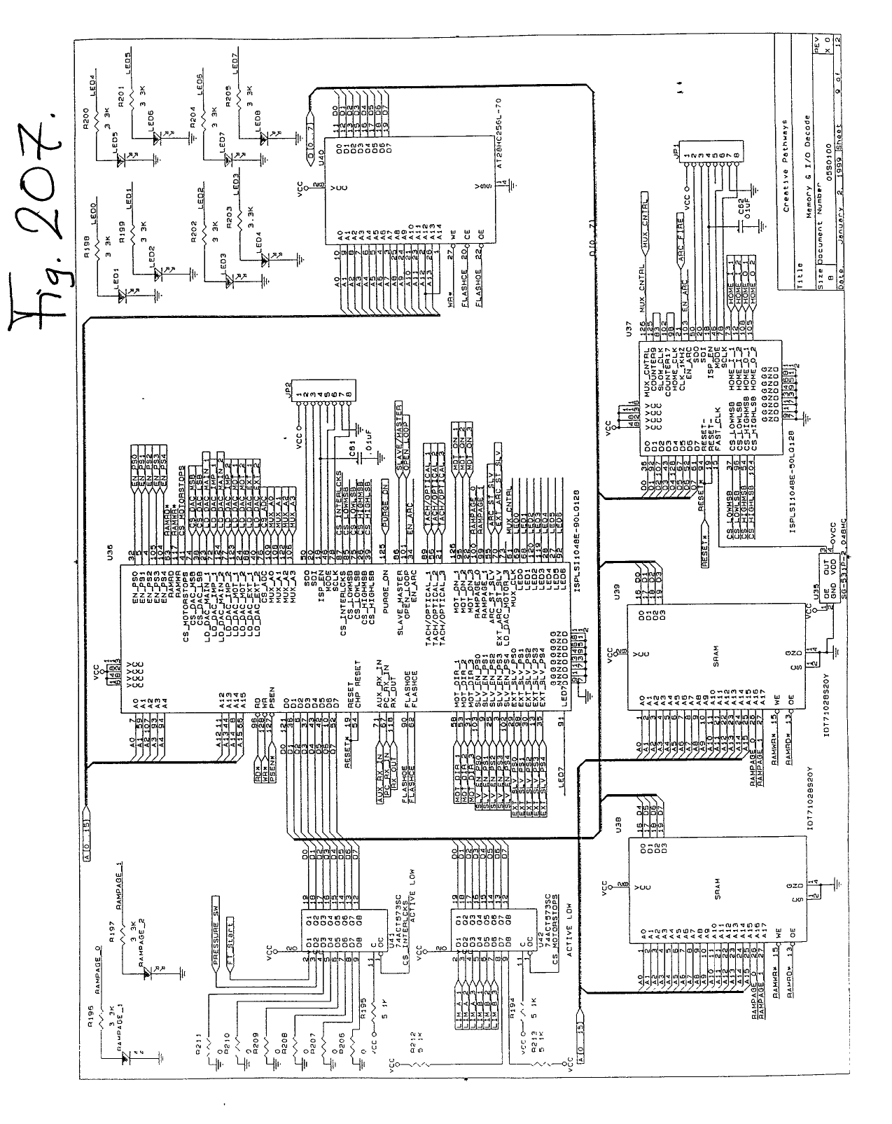

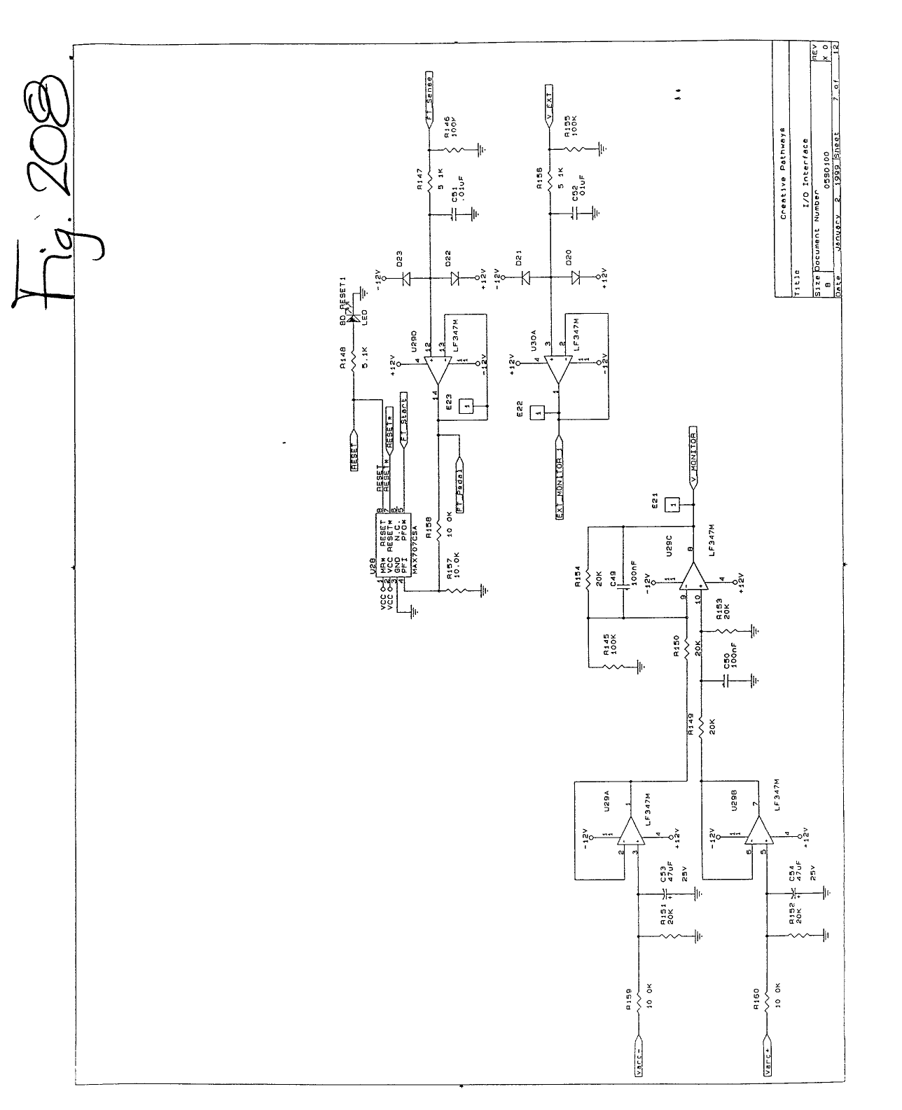

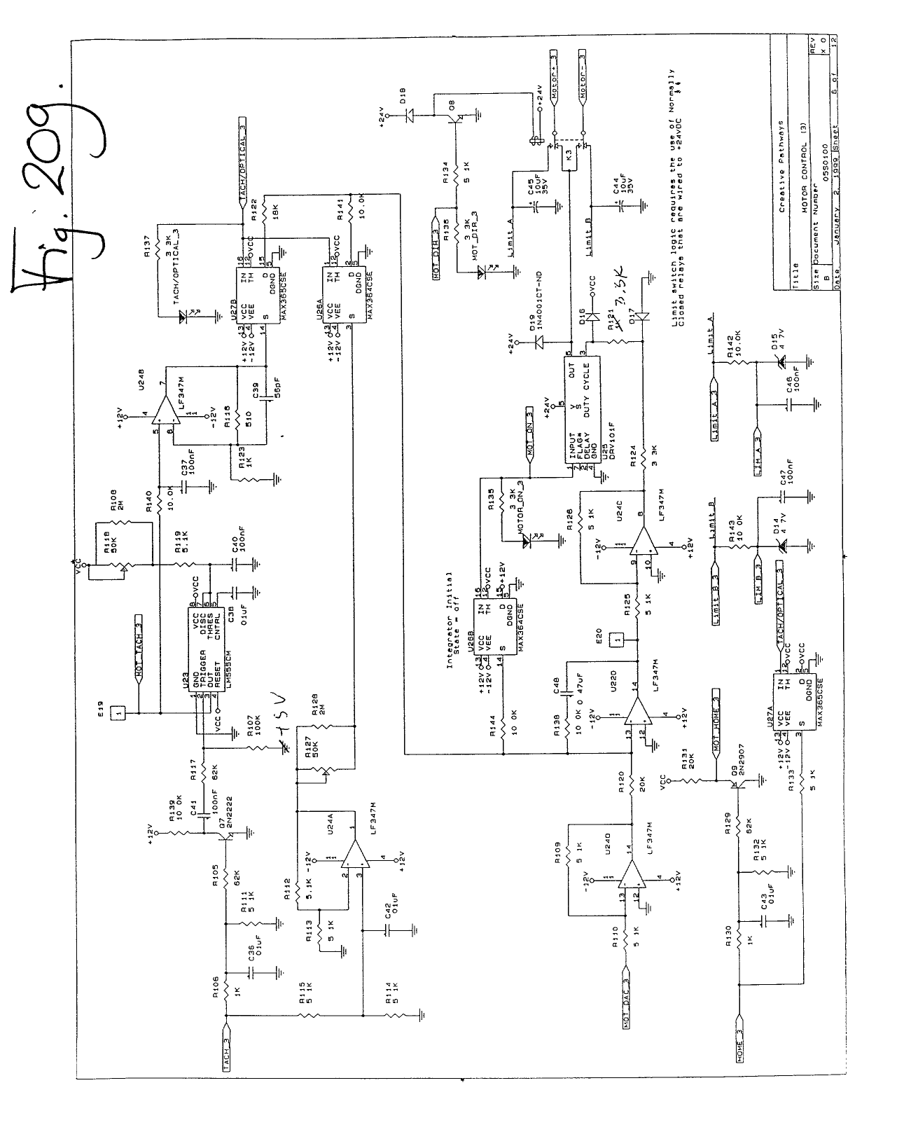

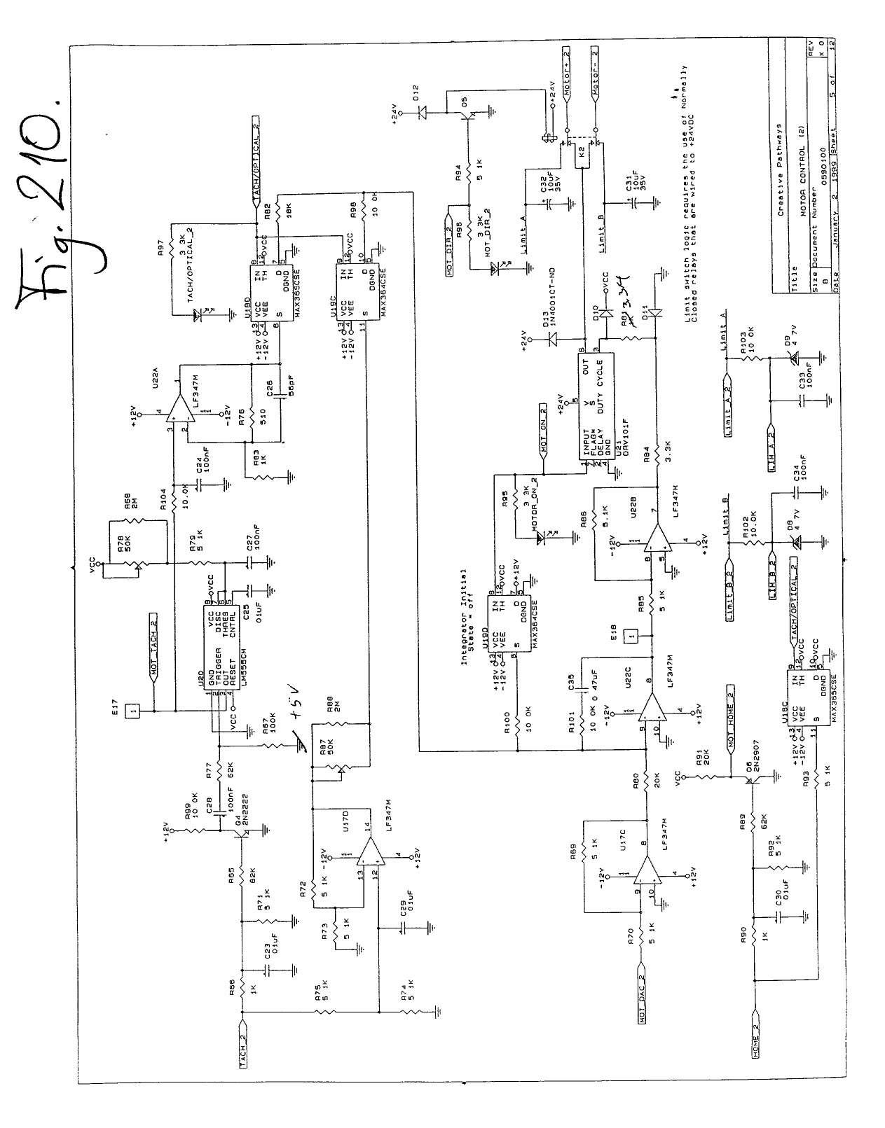

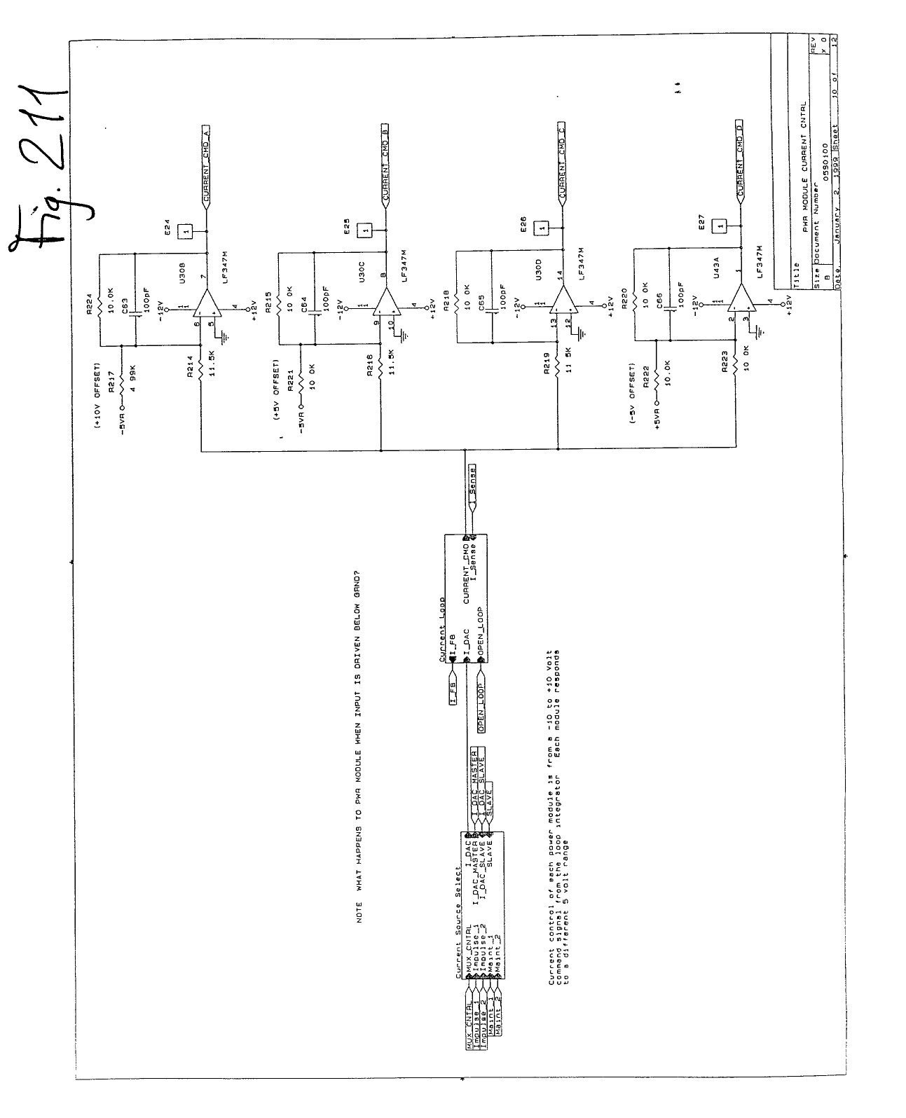

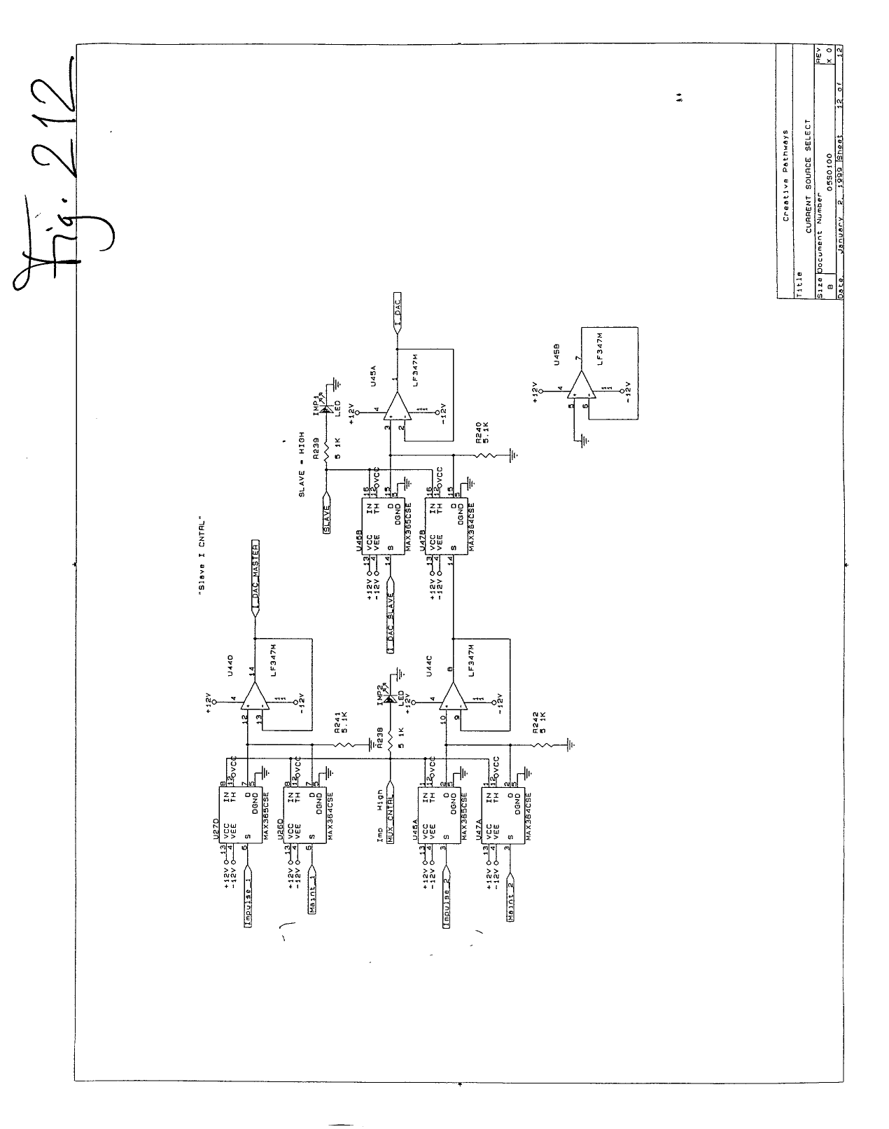

FIG. 110 is a schematic diagram which shows the circuitry within the Computer Control Module 400. FIGS. 111 and 112 provide schematic illustrations of the Microcontroller and Arc Starter circuits. The computer control circuits incorporate concurrent processing architecture and includes a micro-processor 406, a non-volatile memory 408 and an embedded real time control processor. The microprocessor 406 controls and monitors the function of the Welding Power Module 500. The Computer Control Module controls each module individually or in unison. In one embodiment of the invention, an 80486 chip is employed to produce a graphic user interface that is generated on the display 300. Proprietary software developed by Creative Pathways™, Inc. of Torrance, Calif. creates an extremely user-friendly environment using the Microsoft™ Windows™ Operating System. Unlike some previous power supplies, the display is integrated into the Power Supply.

The Computer Control Module performs data logging, generates reports and stores and displays welding parameter and welding power calibration entries. Calibration data may be entered using the touch screen display 300. The micro-processor then stores the calibration points in a non-volatile memory. These data points are then used during all subsequent welds. The processor monitors the weld data, and checks it against the stored calibration data. A report may be generated at the end of weld operation, which would report any errors that occurred during the sequence.

Welding Power Module 500

The Welding Power Module is capable of operating one, two or more welding arcs simultaneously.

Electrical Power Module 600

The Electrical Power Module 600 includes an on/off switch, an EMI filter, a motor control and provides circuitry for housekeeping and management functions. This module uses advanced switching mode current source supply technology. The system may operate at close to a 100% duty cycle at full load.

Applications in Cleanroom & Aerospace Environments

The preferred and alternative embodiments of the present invention may be fabricated for bench-top operation, for use in a lightweight portable scaffold, as part of a cleanroom installation or as part of the specialized equipment that will be employed on the International Space Station.

The invention may be used as a stand-alone unit or may be used in combination with remote control equipment. The PCMCIA cards maybe transported back and forth between welding stations, quality control and inspection sites and engineering and staff meetings where the recorded data can be printed out and analyzed.

Operation of the Power Supply

One embodiment of the invention is specifically designed to be used for welding stainless steel and titanium tubes. The welding process begins with a burst of high voltage energy to start the arc after the purge gas has been turned on. This energy travels down the welding cables through the weld head and across the gap between the electrode and the tube. At the same time, arc start energy radiates off the welding cables and the weld head. This energy is called electromagnetic interference or “EMI noise.” In the present invention, the EMI noise is minimized by the following features:

1) Careful isolation of each power converter, i.e., computer power supply, arc starter, power module, etc.;

2) Proper single point grounding and tight EMI shielding of the entire box;

3) Shielded weld cables;

4) Regulating the amount of energy used for the Arc Start; and

5) Separate shielded compartment for the 486 computer and embedded real time control processor. The individual power units in drawers 504 are programmed to begin delivering current to the weld work piece as soon as the Arc Start voltage ionizes the local atmosphere. When the Arc Start initiates the welding sequence, the power module output voltage drops to a typical voltage of approximately 12 VDC. The current is then regulated as previously programmed using the touch screen display 300. The computer 400 can energize the drawer 504 at random and can sequence among them as required by the needs of a particular welding task.

In addition to the power module control, the embedded control processor 410 regulates the operation of the motor. This control includes speed, ramp speed up and down and home speed.

As is best seen in FIG. 110, the operator has several ways to control the welding sequence. The primary interface is the touch screen display 300. The touch screen display overlays a VGA color monitor. The 486 computer weld software runs within the Microsof™ Windows™ Operating System. This provides the user with a familiar operating system, and minimizes training.

The keyboard 704 and mouse or pointing device 706 provide alternative interfaces to the welding equipment, thereby bypassing the touch screen 300. The printer 710 enables the operator to print for record keeping any of the weld schedules.

In a preferred embodiment of the invention, the embedded real time control processor 410 is a Philips 87C552 or similar micro controller. The 486 computer 406 sends user commands to the embedded controller 410 via a serial interface. The embedded controller then commands and regulates the internal operation of the weld sequence by controlling the following components and variables:

1) Gas Purge Solenoid Valve;
2) Motor Control;
3) Arc Starter;
4) Power Modules; and
5) Output Voltage and Current Sense.

FIG. 111 is a block diagram that depicts the inputs and outputs of the micro controller 410. This figure essentially shows how the micro controller is coupled to each of the power units in drawers 504. The DAC outputs a linear control voltage that determines how much current is supplied to the weld workpiece. The signal is interfaced differentially as well as shielded. The on/off control of the power units is an open collector gate than can be disabled by the watch dog timer. Primarily, the interface is designed for safety and noise. The watch dog timer 412 gets an interrupt from the microcontroller each time the software routine is executed. If for some reason the software routine is not executed, i.e., the computer “hangs-up,” the watch dog timer 412 initiates a reset to the processor and turns off the power modules, thus instantly returning the welder to-a safe state.

FIG. 112 reveals the details of the novel Arc Starter Circuit 450. It works directly off a conventional 110 VAC power source. A voltage doubler and rectifier is connected directly to the 110 VAC input. A capacitor stores the electrical energy to be used as arc start energy. A silicon-controlled rectifier (SCR) becomes a short to ground when commanded by the micro controller. The charge stored on the capacitor dumps to ground through the transformer and SCR. This capacitor discharges with a current spike of approximately 30 amps. The Hyman Trigger transformer 454 then generates a high voltage greater than 4000 volts.

Welding Schedules & Input Parameters

Table One provides a typical set of current level data for a welding operation.

TABLE 1
SET WELD SCHEDULE CURRENT
CREATIVE PATHWAYS
Micro-Impulsar 100

| Schedule Name: | Date: | Misc: |
|---|---|---|
| Boeing Duct Weld | 5/15/92 | 7′ .035 Ti 24 1PM |

| | |
|---|---|
| Impulse Current (0.0-100.0 A) | 75.0 |
| Impulse Start Level (2.0-100.0 A) | 20.0 |
| Maintenance Current (0.0-100.0 A) | 65.0 |
| Maint. Start Level (2.0-100.0 A) | 18.0 |
| Pulse Rate (0-100 PPS) | 75. |
| Duty Cycle (0-100%) | 50. |

A brief explanation of the parameters contained in Table One follows.

| | |
|---|---|
| IMPULSE CURRENT: | (5 to 100 Amps) Arc Impulse Current. Impulse |
| | current can be thought of as the arc penetrating |
| | current. It is meant to penetrate through the |
| | tube and form the inner weld bead. The user |
| | may have to experiment with this setting by |
| | making a test weld, then sectioning the tube |
| | to examine the inner bead. |
| IMPULSE START | (5.0 TO 100.0 Amps). The impulse current at |
| LEVEL: | the start of upslope. This would normally be |
| | about 10% of the impulse current or 5 Amps, |
| | whichever is greater. When upslope is not |
| | being used, set this value the same as the |
| | impulse current. |
| MAINTENANCE | (3 to 100 Amps) Arc Maintaining Current. |
| CURRENT: | Maintenance current or background current is |
| | the current that maintains the arc and heat input |
| | between pulses. |
| MAINT START | (3.0 to 100.0 Amps). Maintenance current level |
| LEVEL: | at the start of upslope. Normally 10% of the |
| | maintenance current level or 4 amps, whichever |
| | is greater. When upslope is not being used, set |
| | this value the same as the maintenance current. |
| PULSE RATE: | (1 to 100 Hz) The number of times per second |
| | the current switches from impulse to |
| | maintenance. Set the frequency so that you can |
| | just notice each individual impulse overlap the |
| | preceding one when inspecting the weld. If the |
| | frequency is too high, the arc will wander and |
| | the edges of the weld will be rough and un- |
| | even. If the frequency is set too low, the weld |
| | will resemble individual overlapping spot |
| | welds. |
| DUTY CYCLE: | (2 to 98%) The percentage of time the current |
| | is at the impulse level. This control allows a |
| | convenient method for making small adjust- |
| | ments in the weld schedule once it has been |
| | developed. To slightly increase penetration, |
| | increase duty cycle 1 or 2 percent; use the |
| | reverse to decrease penetration. |

Table Two contains timing information for a welding sequence.

TABLE 2
SET WELD SCHEDULE TIMING
CREATIVE PATHWAYS
Micro-Impulsar 100

| Schedule Name: | Date: | Misc: |
|---|---|---|
| Boeing Duct Weld | 5/15/92 | 7″, .035 Ti 26 1PM |

| | |
|---|---|
| Pre-Purge time (1-100.0 s) | 4.0 |
| Upslope time (0-100 s) | 5.0 |
| Dwell (0.0-180.0 s) | 47.0 |
| Taper Down Interval (0.0-100.0 s) | 6.0 |
| Taper Down Percent (0-100%) | 50 |
| Down Slope (0.0-100.0 s) | 4.0 |
| Post-Purge time (1-100 S) | 4.0 |

| | |
|---|---|
| PRE-PURGE: | Set this control to allow enough |
| (2 to 100 seconds): | time for the gas to displace all |
| | oxygen in the weld head, i.e. 25 to |
| | 40 seconds for CPI's smaller heads. |
| | For the duct welding system, this |
| | value should be at least 60 seconds. |
| UPSLOPE: | (0 to 100 seconds). Impulse and |
| | maintenance current levels increase to the |
| | dwell levels. |
| DWELL: | During this time, the output current |
| (1 to 180 seconds). | switches between the impulse and |
| | maintenance levels at the frequency and |
| | duty cycle entered. The dwell cycle forms |
| | the main body of the weld. |
| TAPER: | Impulse and maintenance current levels |
| (0 to 100 seconds). | decrease linearly to a certain percentage of |
| | their initial value. Taper can be used as a |
| | second downslope cycle to slowly |
| | decrease the heat input before the current |
| | is finally downsloped to zero. |
| PERCENT TAPER: | The percentage decrease in impulse and |
| (0 to 100 percent). | maintenance current at the end of the taper |
| | cycle. |
| DOWNSLOPE: | Impulse and maintenance current levels |
| (0 to 100 seconds). | decrease uniformly to zero. The |
| | downslope cycle forms the end of the |
| | weld. |
| POST-PURGE: | Set this control for enough time to ensure |
| (1 to 100 seconds). | that the weld does not oxidize or discolor |
| | after it is completed, i.e. 30 to 50 seconds |
| | for CPI's smaller heads, 60 seconds or |
| | more for a duct weld. |

Table Three exhibits rotor control parameters.

TABLE 3
SET ROTOR CONTROL PARAMETERS
CREATIVE PATHWAYS
Micro-Impulsar 100

| Schedule Name: | Date: | Misc: |
|---|---|---|
| Boeing Duct Weld | 5/15/92 | 7″ .035 Ti 24 1PM |

| | |
|---|---|
| Rotor Delay time (0-10.0 s) | 1.0 |
| Rotor Weld Speed (0-100%) | 13 |
| Rotor Start Speed (0-100%) | 30 |
| Rotor Ramp Time (0.0-100.0 s) | 4.0 |
| Rotor Home Speed (0-100%) | 100 |

| | |
|---|---|
| ROTOR DELAY TIME: | Delay time from arc start to fixture |
| (0 to 10.0 seconds). | drive enable. This time period may |
| | be used to delay the fixture drive |
| | for short periods in order that the |
| | arc can penetrate deep into the |
| | material being welded. Rotor delay |
| | is sometimes used with heavy wall |
| | tubing or large diameter thin wall |
| | ducting. |
| ROTOR WELD SPEED: | Weld speed. This is the fixture |
| (1 to 100 percent). | speed that is used during the weld. |
| | Micro-Fit weld heads utilize an |
| | optical encoder feedback system |
| | for speed control accuracy of better |
| | than ¼ percent. |
| ROTOR START SPEED: | This is the fixture speed at the start |
| (0 to 100 percent). | of the weld. The weld head will |
| | start at this speed and ramp up to |
| | the weld speed. If motor ramping |
| | is not being used, set the rotor start |
| | speed to the same value as the rotor |
| | weld speed. |
| ROTOR RAMP TIME: | This is the time that the |
| (0.0 to 100.0 seconds). | weld head takes to ramp |
| | from start speed to weld |
| | speed. If motor ramping is |
| | not required, set this value |
| | to zero. |
| ROTOR HOME SPEED: | Weld head jog and return to |
| (1 to 100 percent). | home speed. For welding, |
| | set this value to a fairly high |
| | number so the weld head |
| | will return to home quickly |
| | at the end of the weld. For |
| | jogging the weld head, set |
| | this value to a lower |
| | number. |

The present invention uses weld heads which utilize optical sensors for both speed and position control. To further simplify the head design, there are actually two home positions.

Table Four reveals data concerning the arc starter.

TABLE 4
SET ARC STARTER PARAMETER
CREATIVE PATHWAYS
Micro-Impulsar 100

| Schedule Name: | Date: | Misc: |
|---|---|---|
| Boeing Duct Weld | 5/15/92 | 7″ .035 Ti 24 1PM |

| | |
|---|---|
| Arc Start Current (0.0-100.0 A) | 50.0 |
| Arc Start Duration (0.0-1.00 S) | 0.15 |

| | |
|---|---|
| START CURRENT: | This is the current that flows |
| (20 to 90 amps). | during the arc start cycle. A setting |
| | of 40 amps is optimal for most |
| | applications. Large diameter thin |
| | wall ducting requires around 50 |
| | amps. |
| START DURATION: | The length of time that the start |
| (.02 to .99 seconds). | current flows. This control is used |
| | for setting arc start intensity. A |
| | setting of 0.15 seconds is a good |
| | starting point, although if you are |
| | welding small diameter thin wall |
| | tubing, a lower setting will be |
| | required. |

III. Electronic Control

Twin electrode welding requires generating two arcs on two electrodes. This allows the operator to weld from the inside of a tube while simultaneously welding from the outside of the tube. This has many advantages, such as increased welding speed, less heat developed in the tube, and reduction in the amount of warpage due to welding.

Twin electrode welding may be implemented either by operating two single electrode power supplies together, or by a totally integrated computer controlled twin power source. Although the explanation that follows pertains to the use of two electrodes, any number of electrodes may be employed by the present invention.

The basic Welder Computer Controlled Power Supply is made up of three basic power source components: a Computer Section, a Power Module Section and an Electrical Section. In general, the Computer Section consist of all the elements typically found in a desktop computer. This computer operates from Microsof™ Windows™, and provides the basic user interface. The Power Module Section contains the power conversion electronics that convert the 110 volt input to low voltage high current weld power. The dynamic range of the power modules is from 2 amps to 100 amps. However, the dynamic range can be easily extended beyond those limits by simply replacing the power modules. The third section is the Electrical Section containing the microcontroller electronics, arc starter and basic interface electronics for the motor, foot pedal and purge solenoid.

Upon start of weld, the Arc Starter is enabled for a predetermined amount of time. At the end of this time, the arc voltage is measured to determine if the weld can continue. The starting current during the arc start is only valid during the arc start time. Initially, this stating current is programmable from the Microsof™ Windows™ control panel. Following the successful arc start, the system begins “up slope.” The starting current for up slope is the same for both impulse and maintenance. The current for impulse and maintenance ramp up together to their final dwell values. Down slope begins after dwell. Down slope is a mirror image of up slope. The impulse and maintenance currents ramp down to a final current value. The final current value is the same as the starting current value. When this value is reached, all of the power modules are turned off. The motor then returns to home at the “Home Speed.”

To perform two welds simultaneously using two computer controlled power supplies, the welding power supplies must be synchronized together. This is accomplished by connecting an interface cable between the two units. From the touch screen, the user selects one of the power supplies to be a “slave.” This means that the other power supply “master” can take control of the basic welder functions. The welders are set up using the same screens as before. The twin welding is initiated by pressing the “Start” weld button. The master microcontroller commands and controls the Arc Start time/duration as well as required welding currents.

Elements that make up the Welder include:

```
  1) Arc Starter
  2) Power Modules: 15 and 30 amps
  3) Motor control
  4) Gas Purge Solenoid Valve
  5) EMI Filtering
  6) Output Voltage & Current Monitor
  7) Low Voltage Power
  8) Microcontroller & System I/O Hardware
  9) Windows Computer Hardware
10) Harnesses, Cabling & Connectors
11) Microcontroller Software
12) 486 Computer Windows Software
13) Touch Screen & Display Hardware
```

A. EMI Suppression

The welding process begins with a burst of high voltage energy to start the arc after the purge gas has been turned on. This energy travels down the welding cables through the weld head and across the gap between the electrode and the tube. At the same time, arc start energy radiates off the welding cables and the weld head into the air—“EMI Noise.” The EMI noise is minimized in this system by:

1) Careful isolation of each power converter, i.e., computer power supply, arc starter, power module etc.;

2) Proper single point grounding and tight EMI shielding of the entire box;

3) Shielded weld cables;

4) regulating the amount of energy used for the Arc Start;

5) Separate shielded compartment for the computer and embedded real time control processor; and

6) Twin electrode interface cable must be shielded with both ends tied to chassis and all signals heavily filter using ferrite beads.

The twin interface cable is especially susceptible given it close proximity and exposure to both ARC's.

B. Operational Details

The individual power modules are progranuned to begin delivering current to the weld piece as soon as the Arc Start voltage ionizes the local atmosphere. When the Arc Start initiates the welding, the power module output voltage drops to a typical voltage of approximately 12 VDC. The actual weld voltage is dependent on the amount of current being used in the weld process, and may vary from 7 volts up to 25 volts. The current is then regulated as previously programmed using the touch screen display.

In addition to the power module control, the embedded control processor regulates the operation of the motor. This control includes speed, ramp speed up and down and home speed. In one embodiment of the invention, the twin microcontroller electronics can control up to three independent motors. Typically, for twin operation, the motor is controlled by the master power supply.

The operator has several ways in which to interface to welder. The primary interface is the touch screen display. The touch screen display overlays a VGA color monitor. The computer weld software runs out of windows. This provides the user with a familiar operating system which minimizes training.

The keyboard and mouse provide alternative interfaces to the welder, bypassing the touch screen. The printer allows the operator to print for record keeping any of the weld schedules.

The Embedded Real Time Control Processor is a Phillips 87C52 or similar microcontroller. The 486 computer sends user commands to the embedded controller via a serial interface. The embedded controller then commands and regulates the internal operation of the weld sequence controlling the following:

1) Gas Purge Solenoid valve;

2) Motor Control;

3) Arc Starter;

4) Power Modules; and

5) Output Voltage & Current Sense.

The microcontroller via the “DAC,” outputs a linear control voltage that determines how much current is supplied to the weld piece. The on/off control of the power module is an open collector gate than can be disabled by the watch dog timer. Primarily, the interface is designed for safety and noise immunity. The watch dog timer gets an interrupt from the microcontroller each time the software routine is executed. If for some reason the software routine is not executed, e.g., the computer “hangs-up,” the watch dog timer initiates a reset to the processor, and turns off the power modules, instantly returning the welder to a safe state.

The following text provides brief explanations of modules controlled by the microcontroller:

1. Power Modules

In one embodiment of the invention, the basic system contains as few as one module or as many as five. Module A can provide output currents from 1 amp to 15 amps. All other modules can deliver from 5 amps to 30 amps.

a. Module A is on all the time.

b. Module B is enabled for currents greater than 10 amps.

c. Module C is enabled for currents greater than 30 amps.

d. Module D is enabled for currents greater than 60 amps.

Each module must be individually turned on with an active high. The current command is provided through the 12 bit DAC. Full scale represents 100 amps. Individual power modules are only enabled when required by the current command. The sharing of current by each module is controlled by the microcontroller. Each module delivers the same percent of the modules full load capacity, maintaining relative component stress equally for all power modules. For example, Module A can deliver 15 amps, and Module B can deliver 30 amps. If both are on and the system is delivering 15 amps, then, the 15 amp module is generating 5 amps (33% of full load), and the 30 amp module is generating 10 amps (33% of full load).

The microcontroller uses a feed back control loop to regulate the amount of current used in the weld process. The microcontroller via the DAC outputs a voltage that corresponds to the amount of current required for the weld piece. This voltage is compared to the system output current sensor and the difference is an error signal or voltage. The current error signal is integrated and then is used to drive the current command signal of each of the power modules. The current command signal is continuously update until the system current exactly matches the current command signal from the microcontroller. The speed of this process is less than a millisecond which allows for the weld impulse frequency to achieve 100 Hz.

The microcontroller turns on enough power modules to provide tilt current required by the weld schedule. The current command signal is part of a control loop that precisely regulates the amount of current being delivered to the work piece. If the weld piece requires more or less voltage to achieve the programmed amount of current, the electronics automatically updates the command signal in less than a millisecond. The individual power modules are designed to turn on and slew to full load in less than a millisecond. This allows the impulse current to turn on and achieve its steady state value very quickly. The software is designed to share the load equally among all the power modules. The power modules only reach full capacity when the output current requirement exceeds 100 amps.

Other features include the ability of the system to start with an initial current less than 2 amps. The beginning of the current upslope is user selectable to the initial current. The end of downslope is hardcoded to 2 amps however, but may be programmed to be user selectable.

2. Purge

This sub-system controls the flow of gas to the work piece. It is turned on with an active high. The user can enable/disable the purge from the Windows™ program. The user can also set-up prepurge and post purge times, such that the work piece purge can be automatically controlled by the computer.

3. Motor Control

Motor control is similar to the Power Module. The Motor must be turned on with an active high. The speed of the motor is controlled through the 12 bit DAC. Full scale represents a speed of 100%. The motor on/off control prevents the motor from creeping while in idle. Motor speed is controlled independent of current. However, it can be ramped up and down same as current.

4. Voltage Sense

This is an 8 bit number that is a measure of the weld head voltage. In one embodiment of the invention, full scale is set to 40 volts. This voltage is displayed on the monitor as part of the graph presented to the operator. The micro-controller needs to use this voltage to determine if the Arc Starter successfully struck an arc. The voltage will be below 25 volts if the arc has been successfully started. After the Arc Start has timed-out, the voltage is checked. If the voltage is less than 25 volts, then the weld process proceeds. If the voltage is above 25 volts, the power modules are all turned off and the motor proceeds to HOME using HOME SPEED.

5. Foot Pedal Control

The foot pedal control is independent of the PC control. An FT Start signal indicates the user has depressed the pedal. At this time, the arc starter is turned on for a predetermined length of time (100 mSec). If the arc starts successfully, the current is controlled by the ADC that measures the voltage that is proportional to the position of the foot pedal. This continues until the FT Start signal goes away, indicating the operator has completed the weld.

IV. Integrated Twin Electrode Computer Controlled Power Supply

In one embodiment of the invention, the integrated power supply operates two electrodes simultaneously by allocating system resources in an optimal manner. For example, two independent arc start circuits are required to ignite the two electrodes. However, only one power converter is required to drive both are starters. The modular power supplies are allocated based upon impulse and maintenance programs for the two electrodes. If the impulse for the two electrodes are operated out of phase, the system can effectively double the welding power. A 100 amp power supply can be made to operate as an effective 200 amp supply. Typically, the impulse duty cycle is 50% or less. In this way, while one electrode is operating in maintenance, the other can be in impulse. The current from each of the power modules is routed to the required electrode as needed. This procedure affords the user a tremendous amount of capability in a very small light weight package.

### CONCLUSION

The present invention will revolutionize the welding industry by providing a compact, low-cost and easy-to-use alternative compared to present conventional welding equipment. The present invention is also eminently capable of being integrated in a CNC System which could automatically accomplish a broad range of complex and precise welding or joining tasks.

Although the present invention has been described in detail with reference to a particular preferred embodiment, persons possessing ordinary skill in the art to which this invention pertains will appreciate that various modifications and enhancements maybe made without departing from the spirit and scope of the claims that follow. The various materials that have been disclosed above are intended to educate the reader about one preferred embodiment, and are not intended to constrain the limits of the invention or the scope of the claims. Although the preferred embodiments have been described with particular emphasis on specific types of metal and tubular workpieces, the present invention may be beneficially implemented with other shapes and other materials such as plastics or composites. The List of Reference Characters which follows is intended to provide the reader with a convenient means of identifying elements of the invention in the Specification and Drawings. This list is not intended to delineate or narrow the scope of the claims.

### LIST OF REFERENCE CHARACTERS

10 Multi-Electrode Welding System

11 Weld head frame

12 Lid

13 Chamber

14 Chamber base

16 Inserts

18 Weld head rotor

20 Inside electrode holder

22 Outside electrode holder

24A Outside electrode

24B Inside electrode

26 Rotor & central drive shaft motor

28 Rotor O.D. electrode holder

30 I.D. spindle electrode holder

32 Flexing taper fingers

34 Taper lock-nut

36 O.D. brush assembly

38 I.D. brush assembly

40 Dielectric housing

42 I.D. spindle

44 Rotor gear drive

46 Rotor brush

48 O.D. rotor brush assembly

50 Idler gear

52 Rotor drive motor pinion gear

54 Rotor ring gear

56 Central shaft gear

58 Central shaft

60 Rotor drive gear

62 Idler gears

64 Meshing gear train

66 Drive motor

68 Drive motor gear

What is claimed is:

1. An apparatus comprising:
a housing means (11, 12, 14) for receiving a workpiece; said housing means (11, 12, 14) including a chamber means (13) for enclosing a volume of generally inert gas; and
an outside electrode means (24B) for discharging energy;
said outside electrode means (24B) being located inside said chamber means (13) but outside of said workpiece;
said outside electrode means (24B) for discharging energy toward said workpiece; and
said outside electrode means (24B) being adapted to move about the exterior of said workpiece.

2. An apparatus as claimed in claim 1, in which said electrical energy is an electrical arc.

3. An apparatus as claimed in claim 1, in which said outside electrode means (24B) is used to perform an outside weld of on a metal workpiece.

4. An apparatus as claimed in claim 1, in which said outside electrode means (24B) is used to modify a workpiece composed of plastic.

5. An apparatus as claimed in claim 1, in which said outside electrode means (24B) is used to modify a workpiece composed of a composite material.
an outside electrode means (24B) for discharging energy;
said outside electrode means (24B) being located inside said chamber means (13) but outside of said workpiece;
said outside electrode means (24B) for discharging energy toward said workpiece; and
said outside electrode means (24B) being adapted to move about the exterior of said workpiece.

6. An apparatus as claimed in claim 1, in which said chamber means (13) may be evacuated and back filled with an inert gas.

7. An apparatus as claimed in claim 1, in which said chamber means (13) may be purged with an inert gas without evacuating.

8. An apparatus comprising:
a housing means (11, 12, 14) for receiving a workpiece; said housing means (11, 12, 14) including a chamber means (13) for enclosing a volume of generally inert gas; and
an inside electrode means (24A) for discharging energy;
said inside electrode means (24A) being located inside said chamber means (13) and being disposed to operate inside of said workpiece;
said inside electrode means (24A) for discharging energy toward said workpiece; and
said inside electrode means (24A) being adapted to move within the interior of said workpiece.

9. An apparatus as claimed in claim 8, in which said electrical energy is an electrical arc.

10. An apparatus as claimed in claim 8, in which said inside electrode means (24A) is used to perform an inside weld of on a metal workpiece.

11. An apparatus as claimed in claim 8, in which said inside electrode means (24A) is used to modify a workpiece composed of plastic.

12. An apparatus as claimed in claim 8, in which said inside electrode means (24A) is used to modify a workpiece composed of a composite material.

13. An apparatus as claimed in claim 8, in which said chamber means (13) may be evacuated and back filled with an inert gas.

14. An apparatus as claimed in claim 8, in which said chamber means (13) may be purged with an inert gas without evacuating.

15. An apparatus comprising:
a housing means (11, 12, 14) for receiving a workpiece; said housing means (11, 12, 14) including a chamber means (13) for enclosing a volume of generally inert gas;
an inside electrode means (24A) for discharging energy;
said inside electrode means (24A) being located inside said chamber means (13) and being disposed to operate inside of said workpiece;
said inside electrode means (24A) for discharging energy toward said workpiece; and
said inside electrode means (24A) being adapted to move within the interior of said workpiece; and
an outside electrode means (24B) for discharging energy;
said outside electrode means (24B) being located inside said chamber means (13) but outside of said workpiece;
said outside electrode means (24B) for discharging energy toward said workpiece; and
said outside electrode means (24B) being adapted to move about the exterior of said workpiece.

16. An apparatus as claimed in claim 15, in which said electrical energy is an electrical arc.

17. An apparatus as claimed in claim 15, in which said inside electrode means (24A) is used to perform an inside weld on a metal workpiece and said outside electrode means (24B) is used to perform an outside weld on said metal workpiece.

18. An apparatus as claimed in claim 15, in which both said electrode means (24A & 24B) are used to modify a workpiece composed of plastic.

19. An apparatus as claimed in claim 15, in which both said electrode means (24A & 24B) are used to modify a workpiece composed of a composite material.

20. An apparatus as claimed in claim 15, in which said chamber means (13) may be evacuated and back filled with an inert gas.

21. An apparatus as claimed in claim 15, in which said chamber means (13) may be purged with an inert gas without evacuating.

22. An apparatus as claimed in claim 15, in which both electrode means (24A & 24B) revolve around the longitudinal axis of said workpiece, but one on the outside and the other on the inside of said workpiece, to perform simultaneous inside and outside welds.

23. An apparatus as claimed in claim 15, in which the motion of said electrode means (24A & 24B) are independently controllable.

24. An apparatus as claimed in claim 23, in which one of said electrode means may trail the other in its motion relative to said workpiece.
